(19) United States
(12) Patent Application Publication
(10) Pub. No.: US 2025/0297167 A1
(43) Pub. Date: Sep. 25, 2025

(54) PORTABLE GAS-TO-LIQUIDS PLANT FOR FORMING LIQUID HYDROCARBONS FROM GASEOUS HYDROCARBONS

(71) Applicant: DeWalch Technologies, Inc., Houston, TX (US)

(72) Inventors: Norman Binz Dewalch, Houston, TX (US); Carlos F. Rivera Montes, Houston, TX (US)

(73) Assignee: DeWatch Technologies, Inc., Houston, TX (US)

(21) Appl. No.: 19/089,552

(22) Filed: Mar. 25, 2025

Related U.S. Application Data
(60) Provisional application No. 63/569,273, filed on Mar. 25, 2024.

(51) Int. Cl. C10G 2/00; B01J 21/04; B01J 23/755

(52) U.S. Cl. CPC C10G 2/341; B01J 21/04; B01J 23/755; C10G 2/33; C10G 2300/104; C10G 2300/4081

(57) ABSTRACT

A portable gas-to-liquids (GTL) plant includes a reforming reactor and a Fischer-Tropsch (FT) reactor. The reforming reactor forms syngas from an oxidizer stream and a gaseous hydrocarbon feed. The FT reactor forms a hydrocarbon outlet stream from the syngas. The hydrocarbon outlet stream includes carbon compounds having about eight to about 20 carbons.

### CROSS-REFERENCE TO RELATED APPLICATION

This application claims the benefit of priority to U.S. Provisional Application Ser. No. 63/569,273, filed Mar. 25, 2024, the contents of which are hereby incorporated by reference.

### TECHNICAL FIELD

This disclosure relates to methods of producing liquid hydrocarbons from feedstocks comprising methane.

### BACKGROUND

Hydrocarbon fields often produce both oil and natural gas. The oil is generally the higher-volume product and is sent for further processing by trucks or pipelines. Given the cost of high-pressure gas pipelines, recovery of the natural gas is generally not economical, especially for smaller hydrocarbon fields and more remote hydrocarbon fields. In the past, the natural gas was often flared at these sites. This wasted both the value and released a substantial amount of carbon dioxide. Presently, the natural gas is compressed and reinjected for enhanced oil recovery. However, this does not take full advantage of the economic value of the resource in the hydrocarbon fields.

Further, remote natural gas fields are often not economical to produce. Without a pipeline for transport, the natural gas is a stranded resource, without economic value.

### BRIEF DESCRIPTION OF DRAWINGS

FIG. 1A is a block diagram of a portable gas to liquids (GTL) plant.

FIG. 1B is a block diagram of a portable GTL plant.

FIG. 2 is a process flow diagram of a method for using a portable GTL plant at a field site.

FIG. 3 is a side view of a portable GTL plant mounted on a skid unit that is folded and placed on a trailer for transportation to a hydrocarbon field.

FIG. 4A is a side view of the portable GTL plant in the folded position after unloading from the trailer.

FIG. 4B is a top view of the portable GTL plant in the folded position.

FIG. 4C is a front view of the portable GTL plant in the folded position.

FIG. 4D is a back view of the portable GTL plant in the folded position.

FIG. 5A is a side view of the portable GTL plant in the open position.

FIG. 5B is a top view of the portable GTL plant in the open position.

FIG. 5C is a top view of the portable GTL plant in the open position with the air-cooling units removed to show units underneath.

FIG. 5D is a front view of the portable GTL plant in the open position.

FIG. 5E is a back view of the portable GTL plant in the open position.

FIG. 6A is a cross-sectional view of a vortex-assisted autothermal reformer including a partial oxidation burner and a catalyst reforming vessel.

FIG. 6B is a close-up cross-sectional view of the partial oxidation burner of FIG. 6A.

FIG. 6C is a view of the internal liner of the mixing chamber of the partial oxidation burner of FIG. 6A.

FIG. 6D is a cross-sectional view of a vortex-assisted autothermal reformer including a partial oxidation burner and a catalyst reforming vessel.

FIG. 6E is a close-up cross-sectional view of the partial oxidation burner of FIG. 6D.

FIG. 7 is a cross-sectional view of the Fischer-Tropsch reactor showing the pivot point and the catalyst in the tubes.

FIG. 8 is a process flow diagram of a method for using a portable GTL plant at a field site.

FIG. 9 is a process flow diagram of an example simulation of a portable GTL plant.

### DETAILED DESCRIPTION

Embodiments described herein provide a portable gas to liquids (GTL) plant used to convert gases that include methane and other gaseous hydrocarbons, such as C6 or lower, to a liquid product, such as diesel. The portable GTL plant is constructed on a skid mount that can be transported on a trailer. All catalysts are preloaded into the reactors of the portable GTL plant. The portable GTL plant is transported to a site, for example with a stranded natural gas supply, folded open into an operational position, connected to utilities and feedstocks, and started.

In some embodiments, the portable GTL plant includes a remote-control system, allowing the portable GTL plant to be monitored and operated. From a remote location, for example, in a control room that controls a number of portable GTL plants in different locations. This may be performed using a satellite uplink to control a DCS at the site of the portable GTL plant, through a microwave datalink, or through physical Internet connection, cellular data network, satellite data network or other suitable data communication network.

After a period of operation, the portable GTL plant will need servicing, such as catalyst replacement or regeneration, among others. At that point, the portable GTL plant is shut down, purged, disconnected from utilities, and folded closed into a transportation configuration. The portable GTL plant may then be loaded onto a trailer for transportation back to a central site for servicing. A replacement portable GTL plant can then be brought to the site and started with minimal downtime.

The portable GTL plant can be implemented to increase the value of a stranded gas field. Because the portable GTL plant is transportable across typical roads and highways, the portable GTL plant can be transported to a stranded gas field and convert at least a portion of gas (e.g., natural gas) from the stranded gas field into liquid hydrocarbons of higher economic value. Once converted to liquid hydrocarbons, the liquid hydrocarbons can be stored locally in holding tanks. The liquid hydrocarbons can be transported—to another location, for example, for further processing or sale to another user. In some implementations, the portable GTL plant converts hydrocarbons originating, for example, from gasification of coal and/or biomass into liquid hydrocarbons of higher economic value. In some implementations, the portable GTL plant converts gases originating, for example, from gasification of organic matter such as wood or agricultural waste. In some implementations, the portable GTL plant converts gases originating, for example, from shale gas fields having little to no associated natural gas liquids or crude oil. In some implementations, the portable GTL plant converts hydrocarbons originating, for example, from processing of crude oil (e.g., natural gas separated from crude oil) into liquid hydrocarbons of higher economic value.

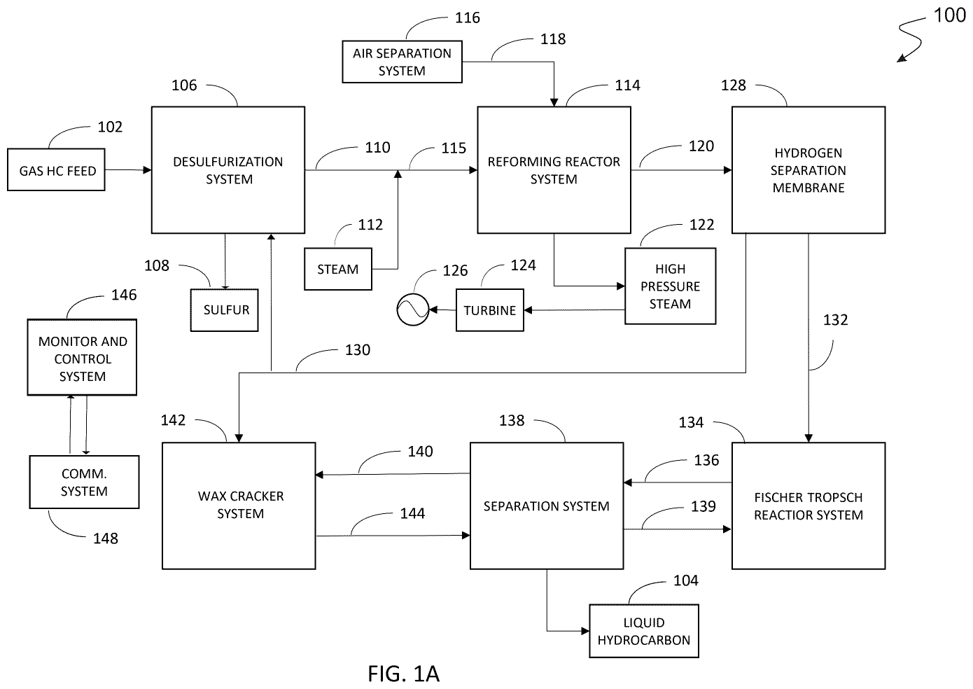

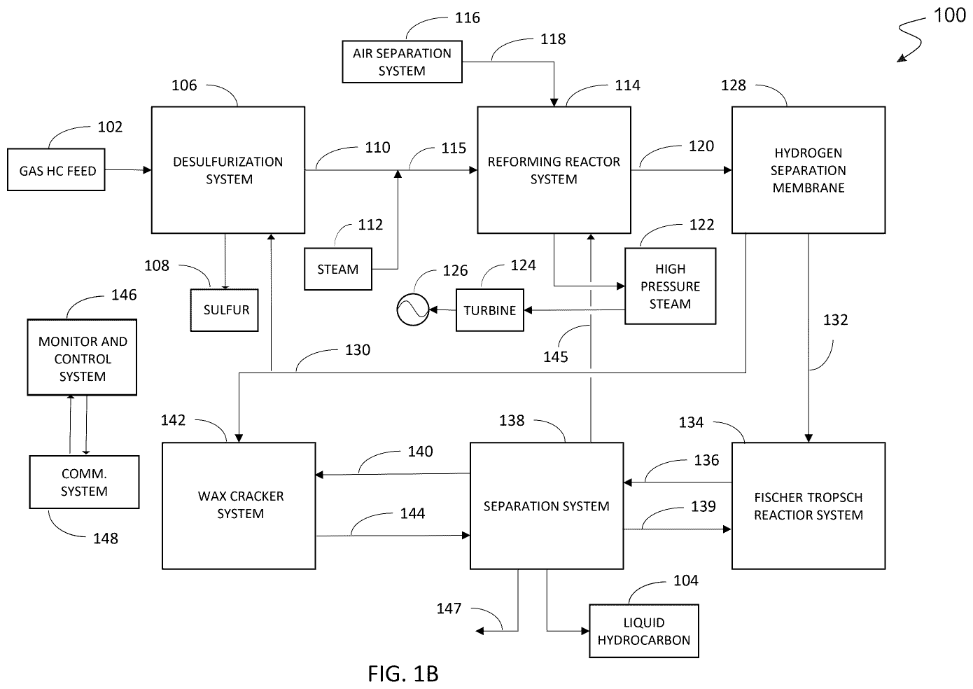

FIG. 1A is a block diagram of a portable gas-to-liquids (GTL) plant 100. In the portable GTL plant 100, a gaseous hydrocarbon (HC) feed 102 is used to produce a liquid hydrocarbon 104 as a product. For example, in some embodiments the gaseous HC feed 102 includes methane, such as in a stranded natural gas. In some embodiments, the gaseous HC feed 102 includes methane, such as natural gas from non-stranded gas fields. In some embodiments, the gaseous HC feed 102 includes methane, such as natural gas from gathered sources, such as a gas gathering plant, a pipeline, a gas liquification plant, or any combinations of these. The gaseous HC feed 102 can include other hydrocarbons, such as ethane, propane, and the like. The liquid hydrocarbon 104 can include diesel fuel, gasoline, alcohols, and the like.

The gaseous HC feed 102 is fed to a desulfurization system 106 to remove sulfur 108 from the gaseous HC feed 102, forming a desulfurized stream 110. In some embodiments, the desulfurization system 106 includes a hydrodesulfurization reactor that uses a catalyst and a hydrogen to convert sulfur compounds to elemental sulfur. Any number of commercial hydrodesulfurization catalysts may be used in the hydrodesulfurization unit, such as a cobalt-promoted molybdenum catalyst (Co—Mo), which is a mixture of MoS₂ and Co₉S₈ supported on alumina. For example, the catalyst may be selected from the HyProGen 100 series of hydrodesulfurization catalysts available from Clariant of Louisville, Kentucky, USA. As described herein, the hydrogen can be provided from downstream units. The sulfur 108 can form a product stream from the portable GTL plant 100. In some embodiments, the desulfurization is performed upstream of the portable GTL plant 100. In these embodiments, the desulfurization system 106 may be omitted.

The desulfurized stream 110 is blended with steam 112 and fed to a reforming reactor system 114 as a feed stream 115. The feed stream 115 can be preheated by waste heat from the reforming reactor system 114 before addition. An air separation system 116 is used to generate an oxygen stream 118 which is also fed to the reforming reactor system 114. In the reforming reactor system 114 the desulfurized stream 110 is partially combusted to form a combustion stream including steam, carbon oxides, hydrogen, and unconverted methane. The combustion stream is then fed to a reforming catalyst to further the conversion to a syngas stream 120, comprising steam, carbon oxides, hydrogen, and, in some cases, unconverted methane. In some embodiments, the combustion stream is fed to a chamber free of a catalyst to convert the combustion stream into the syngas stream 120. In various embodiments, the desulfurized stream 110 is introduced to the reforming reactor system 114 separately from the steam 112 or the steam is mixed with the oxygen stream 118 from the air separation system and introduced to the reforming reactor.

The reforming catalyst can be any number of commercial reforming catalysts, for example, based on nickel metal supported on alumina. For example, the reforming catalysts can be ReforMax® LDP Plus available from Clariant.

As the partial combustion process is exothermic, cooling generates high-pressure steam 122 from heat remaining after the endothermic reforming process, for example, from cooling the syngas stream 120. In various embodiments, the high-pressure steam 122 is used to power a steam turbine 124 to generate electrical power 126, which may be used to power the process, and provide another product output. For example, the electrical power can be used for resistive heating to generate heat which can be used in the process. After flowing through the turbine, the high-pressure steam 122 is reduced in pressure, and a portion can be used as the steam 112 fed to the reforming reactor system. In some embodiments, the steam can be sourced from high-pressure steam sources for example, such as the high-pressure steam 122, and a portion of the steam can be fed to the reforming reactor system. In other embodiments, the steam can be sourced from other heat sources, including low pressure steam generation sources.

The syngas stream 120 is passed through a hydrogen separation membrane 128, in which a portion of the hydrogen is separated from the syngas stream 120 as a permeate, forming a hydrogen stream 130. The retentate stream 132 which includes the carbon monoxide and remaining hydrogen is used as a feed stream to a Fischer-Tropsch (FT) reactor system 134. In some embodiments, the hydrogen separation membrane 128 is used to adjust the ratio of hydrogen to carbon monoxide ratio in the feed to the FT reactor system 134.

In the FT reactor system 134, the retentate stream 132 is reacted over a catalyst to form a hydrocarbon product stream 136. The catalyst used for the Fischer-Tropsch reaction is generally based on iron, cobalt, nickel, ruthenium, rhenium, or combinations thereof, supported on alumina or other materials. For example, the FT catalyst may be INFRA S2 available from INFRA Synthetic Fuels, Inc., of Houston, Texas, USA. The catalyst may be selected to prefer the production of high molecular weight linear alkanes, such as diesel fuels, or other materials. Testing was performed using a catalyst that included about 20 wt. % cobalt, 0.5% rhenium, and 2% lanthanum. The flow rate on the inlet and the outlet of a test reactor including a single tube of catalyst was measured and the feed and tail gas were analyzed, giving a conversion rate for CO of about 41.6% per pass. From this measurement, it can be determined that using 13.4 MCF of natural gas in the process will generate about one barrel of Fischer Tropsch product.

The hydrocarbon product stream 136 includes liquid hydrocarbon 104, for example, C-5 to C-20, and other products such as FT oil and wax, which includes C-21 to C-30 compounds.

The hydrocarbon product stream 136 is sent to a separation system 138. The separation system 138 can include one or more distillation columns, as well as solid liquid and gas liquid separation systems, such as flash drums. A wax stream 140 is separated from the liquid hydrocarbon 104 and sent to a wax cracker 142. In some embodiments, a portion of the wax stream 140 is not sent to the wax cracker 142 but is isolated as a separate product stream.

In the wax cracker 142, the wax stream 140 is reacted with hydrogen from the hydrogen stream 130 in the presence of a catalyst, for example, in a hydrocracking reaction. The hydrogen can be provided from other sources, for example, from a hydrogen tank during start-up, or from a renewable source, such as solar powered electrolysis. The catalyst can be a standard commercial hydrocracking catalyst. This may be, for example, a bifunctional catalyst that includes an acidic support for cracking, such as alumina or silica, and metal domains for hydrogenation, such as platinum, palladium, molybdenum sulfide, and the like. For example, the hydrocracking catalyst can be selected from the Zeolyst™ series of catalysts available from Shell Corp. of London, England. The specific catalyst can be selected to maximize the production of target compounds, such as the Zeolyst™ Z-FX series which can be selected to increase yields of diesel fuel.

From the wax cracker 142, a cracked stream 144 is returned to the separation system 138. Accordingly, a higher yield of the liquid hydrocarbon 104 is achieved from the cracked FT wax. As described herein, the remaining gases from the process can be used for other purposes, for example, a portion may be bled to a flare to lower the build up of inert gases, such as carbon dioxide, nitrogen, and argon. Depending on the energy content, a portion may be used as fuel gas for other processes. Further, a portion may be recycled to the FT reactor system 134 to increase the product yield. In addition, a recycle stream 139 can be recycled to the FT reactor system 134 from the separation system 138 in addition to or instead of the gases from the wax cracker 142.

A monitor and control system 146 is coupled to sensors on the process units, including, for example, temperature sensors, flow sensors, power sensors, pressure sensors, analysis sensors, and the like. The monitor and control system 146 is also coupled to actuators on the process units, including, for example, solenoid valves, motor valves, relays, heaters, and the like. In some embodiments, the monitor and control system 146 includes the basic control routines to operate the portable GTL plant 100, for example, adjusting the flow of the gaseous HC feed 102 to the desulfurization system 106, then on through the succeeding process units to form the liquid hydrocarbon 104. The overall operation of the system can be monitored by the proportion of gaseous HC feed 102 that is converted to the liquid hydrocarbon 104. The monitor and control system 146 is coupled to a communication system 148.

The communication system 148 sends the measured process parameters, including, for example, temperatures, pressures, flow rates, power output, chemical analysis results, and actuator positions, to an operator that is remote to the portable GTL plant 100. The communication system 148 may also send the current operational settings, for example, if the monitor and control system 146 includes the operational programs.

The communication system 148 may use a satellite uplink, a microwave datalink, an optical fiber datalink, an optical datalink, or a wired Internet connection. In some embodiments, the monitor and control system 146 is only used to monitor sensor outputs and control actuators, while the operational programs reside in a remote system. Generally, this configuration would only be used if the communications between the communication system 148 and the remote system were highly reliable, such as if an optical fiber datalink were used. Further, the monitor and control system 146 may include shut down or throttle down programs in case of the loss of communications or the inability to make adjustments to bring the system back into stable operation.

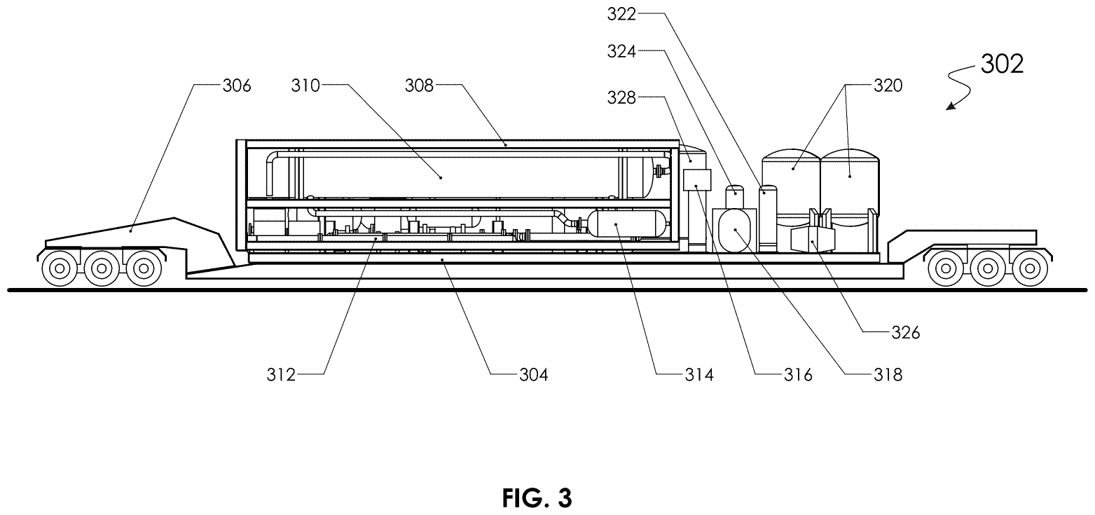

The systems used in the portable GTL plant 100, as described with respect to FIG. 1A, each include a number of individual processing units. The individual processing units are described in further detail with respect to FIGS. 3-7. Discussion with respect to those figures will refer to the particular system that the processing unit belongs to in FIG. 1A.

There are several opportunities for heat and process integration in the portable GTL plant 100. For example, the retentate stream 132 can be heated by heat exchange with the hydrocarbon product stream 136 and/or heat exchange with steam generated from waste heat. As another example, heat generated by the highly exothermic FT reaction(s) can be used to generate high pressure steam, which can be used by the steam turbine generator 520 to generate power, supply heat to process(es) in the plant 100, or both. As another example, heat used by the separation system 138 to separate the hydrocarbon product stream 136 can be sourced from steam generated from captured waste heat, power generated by the steam turbine generator 520, or both. As another example, the wax stream 140 can be heated by heat exchange with the cracked stream 144, steam generated from captured waste heat, power generated by the steam turbine generator 520, or any combinations of these. As another example, heat from the syngas can be used to generate high pressure steam 122, which can be used by the steam turbine generator 520 to generate power, supply heat to process(es) in the plant 100, or both. Effective combinations of heat exchangers for cooling and heating across process streams can reduce overall energy requirements of the plant 100, thereby reducing the size of heat exchange equipment (e.g., air coolers) and reducing the overall physical footprint of the plant 100. Using heat transferred from a higher temperature stream to lower temperature stream can reduce the energy that would otherwise be provided to the portable GTL plant 100 while at the same time reducing the requirement for air coolers to cool the higher temperature stream.

FIG. 1B is a block diagram of a portable GTL plant 100′. The portable GTL plant 100′ includes the same processing units as the GTL plant 100 shown in FIG. 1A. In some implementations, as shown in FIG. 1B, separation system 138 separates a portion of the hydrocarbon product stream 136 to form a reformer recycle stream 145. The reformer recycle stream 145 can include lighter hydrocarbons (e.g., methane, propane, butane, pentane, hexane, heptane, and octane) that have flashed from the hydrocarbon product stream 136 in the separation system 138. The reformer recycle stream 145 can be recycled to the reforming reactor system 114 for re-processing and forming additional syngas for conversion into heavier hydrocarbons by the Fischer-Tropsch reactor system 134. Recycling of the reformer recycle stream 145 can increase the overall conversion efficiency of light hydrocarbons into liquid hydrocarbons by the portable GTL plant 100′.

In some cases, tail gas 147 (also referred to as vent gas or off-gas) is produced by the Fischer-Tropsch reactor system 134. The separation system 147 can separate the tail gas 147 from the hydrocarbon product stream 136. The tail gas 147 can then be sent to a flare for burning.

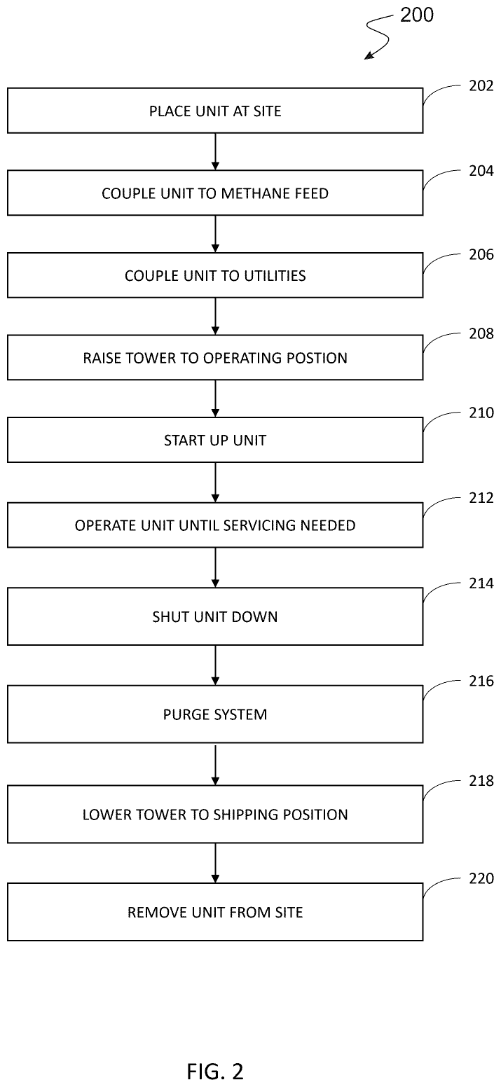

FIG. 2 is a process flow diagram of a method 200 for using a portable GTL plant at a field site. The method begins at block 202, when the portable GTL plant is placed at the field site. For example, the portable GTL plant may be mounted on a skid that is transported by a trailer to the field site. At the field site, the portable GTL plant is offloaded from the trailer.

At block 204, the portable GTL plant is coupled to a methane feed. For example, this may be a natural gas feed from a liquid gas separator. Depending on the production of liquid hydrocarbons that is desired, all or only a portion of the natural gas feed may be sent to the portable GTL plant. For example, another portion may be compressed and reinjected into the reservoir for enhanced oil recovery.

At block 206, the portable GTL plant is coupled to utilities. For example, the portable GTL plant can be coupled to a water feed, a power grid, a steam header, and the like. For very remote sites, a portable utility trailer can be brought in for startup. Once the portable GTL plant is operational, the portable utility trailer could be removed, as the portable GTL plant will provide most of its own utilities, including power and steam. In some embodiments, the portable GTL plant is started without any outside utility connections other than the natural gas.

At block 208, a rotatable tower including process units is raised to a vertical position for operations. The process units include a Fischer-Tropsch reactor and, in some embodiments, a distillation tower. In some embodiments, the catalyst in the Fischer-Tropsch reactor is encapsulated. In some embodiments, the catalyst is encapsulated to maintain packing and to protect the catalyst during transport. In some embodiments, prior to start up at block 210, the encapsulation is removed from the catalyst.

At block 210, the portable GTL plant is started. This may be performed by preheating the operational units, starting the air separation plant, then starting the feed to the desulfurization vessel. The ignition of the partial combustion in the reforming reactor to produce the syngas will provide the rest of the energy needed for startup.

At block 212, the portable GTL plant is operated to provide the liquid hydrocarbon product, as well as other products such as electricity, heat, sulfur, and the like. As described herein, in some embodiments, the portable GTL plant is remotely operated from a central facility that controls a number of portable GTL plants and does not require regular, on-site human presence. The operation continues until the central facility notes that the portable GTL plant needs servicing.

At block 214, the portable GTL plant is shut down. For example, this may include closing in feed valves, allowing the unit cool, draining water from lines, and draining hydrocarbons from vessels and catalyst beds.

At block 216, the portable GTL plant is purged. This may be done with a nitrogen gas flow to send remaining traces of liquids and gases to a flare header. In some embodiments, an immobilizing substance may be introduced into the catalyst tubes to encapsulate and immobilize the catalyst for transport. Some example substances for immobilizing the catalyst for transport include substances such as a wax, a gel or a liquid that surrounds the catalyst. These substances are removed, for example, prior to operation or regeneration of the catalyst. In some embodiments, FT wax is introduced to the catalyst tubes to surround the catalyst, and the FT wax is solidified for transport and can be melted prior to operation or regeneration.

At block 218, the unit is prepared for transport and the tower is lowered to the shipping position. For example, a hinged structure that includes the FT reactor and the distillation column may be lowered to a horizontal position relative to the skid mount.

At block 220, the skid mount is loaded onto a trailer to be taken back to a servicing facility for servicing, for example, for regeneration of the catalyst, repair, preventative maintenance of equipment, or any combinations of these. The portable GTL plant is then removed from the site. A replacement for the portable GTL plant may then be brought in and set in place, for example, returning to block 202.

The ease of replacement of the portable GTL plant, the remote operation, and the off-site servicing allow the portable GTL plant to be provided as a service to an oilfield operator. For example, an oilfield operator may contract with the service to place the portable GTL plant at the site, operate the portable GTL plant providing a share of profits from the liquids as a royalty, and then removing the portable GTL plant from the site when operations are completed, for example, when the oilfield is depleted of gaseous hydrocarbons. In some embodiments, the natural gas is purchased from the field operator and used to produce the liquid hydrocarbon, and other, products.

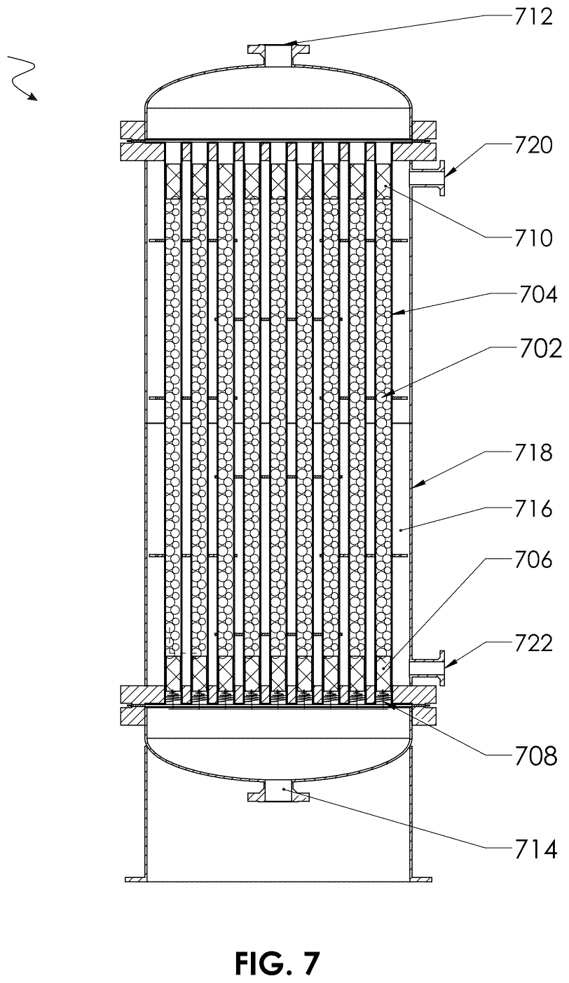

FIG. 3 is a side view of a portable GTL plant 302 mounted on a skid unit 304 that is folded and placed on a trailer 306 for transportation to a hydrocarbon field. Referring also to FIGS. 1A and 1B, the associated system is mentioned in reference to the structures discussed below. The portable GTL plant 302 has a hinged structure 308, shown in a folded position, which holds the FT reactor 310 (FT reactor system 134), and is discussed further with respect to FIG. 7. This view also shows a distillation column 312 (separation system 138), and other process units, such as a FT steam drum 314 (FT reactor system 134).

A number of other process units are visible in this illustration, including equipment used for oxygen production in the air separation system 116 such as a vacuum pressure swing adsorption (VPSA) intake filter 316 which feeds a VPSA inlet blower 318. The VPSA intake filter 316 prevents the intake of dust and other materials into the VPSA inlet blower 318. Other parts of the air separation system 116 are visible in this view including the VPSA adsorption vessels 320, and the VPSA silencers 322 and 324. The VPSA absorption vessels 320 contain the zeolite used to absorb nitrogen and other components from the air, allowing the oxygen to pass through. The VPSA inlet blower 318 compresses the air that is fed to the VPSA adsorption vessels 320. The VPSA blower silencer 322 acts as a muffler to lower the sound from the VPSA inlet blower 318. A VPSA heat exchanger 326 is used to remove heat from the compressed gas prior to feeding the compressed gas to the VPSA adsorption vessels 320. The oxygen produced in the system is stored in an oxygen accumulator 328. Although the air separation system 116 is described as a VPSA oxygen generation system in this example, other systems can be used to generate oxygen, including pressure swing adsorption, low temperature membrane separation, among others.

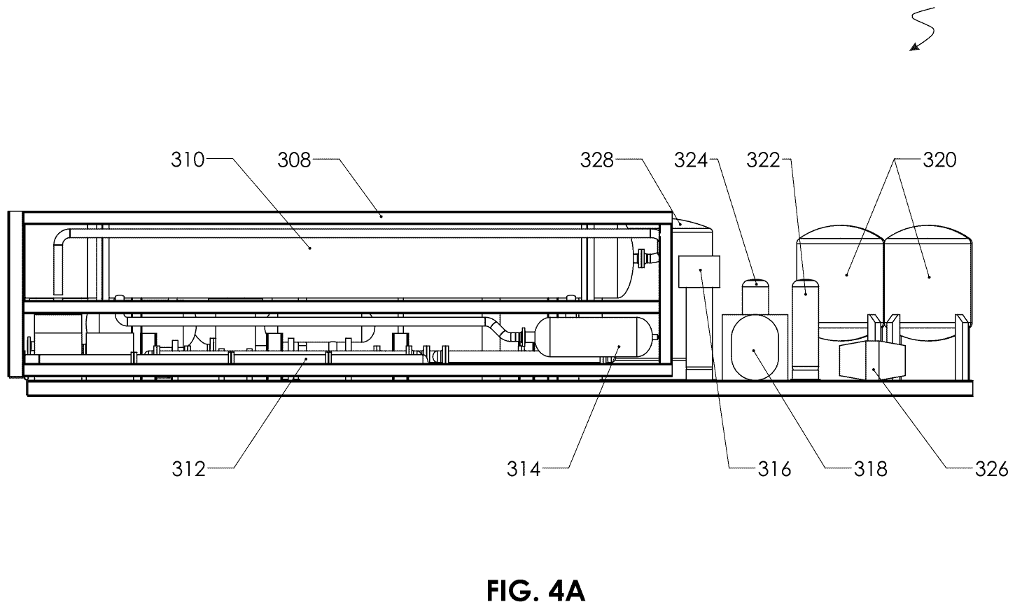

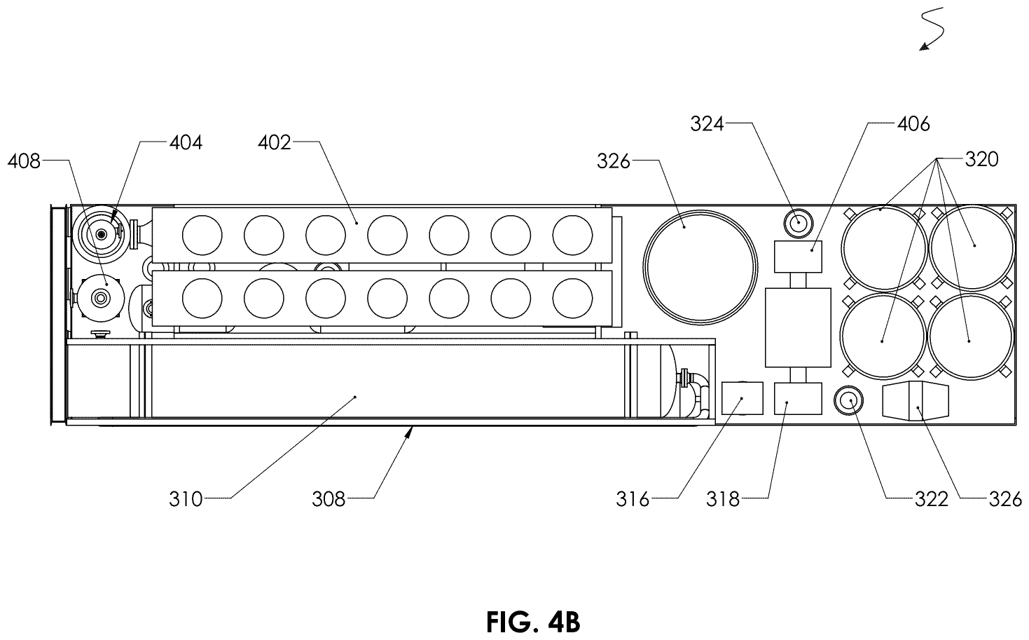

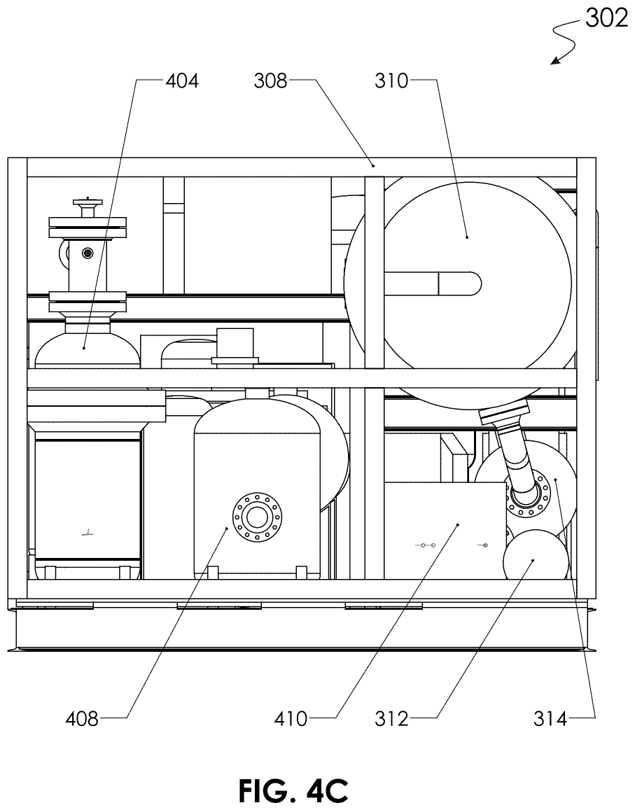

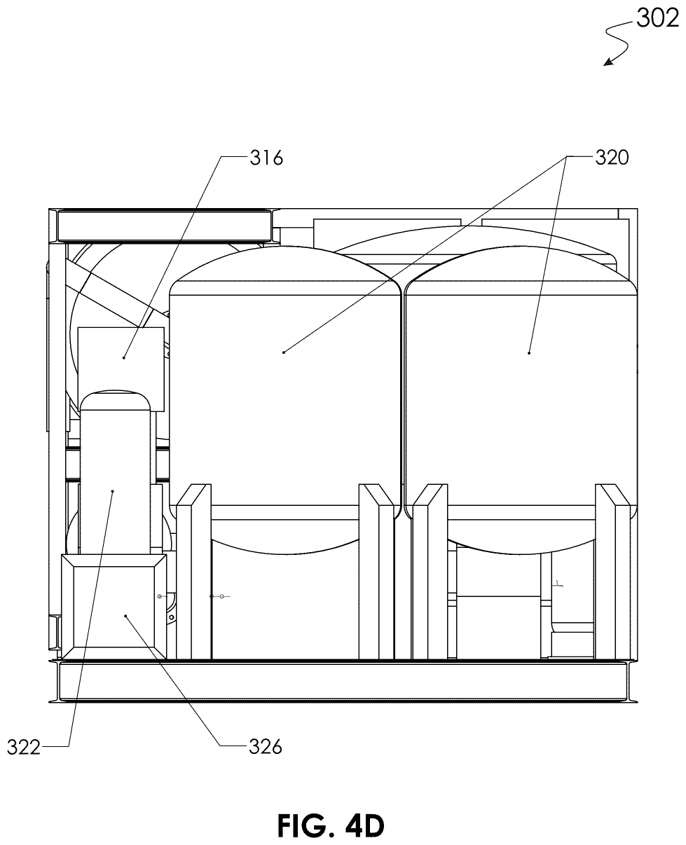

FIG. 4A is a closer side view of the portable GTL plant 302 in the folded position after unloading from the trailer. Like numbered items are as described with respect to FIG. 3.

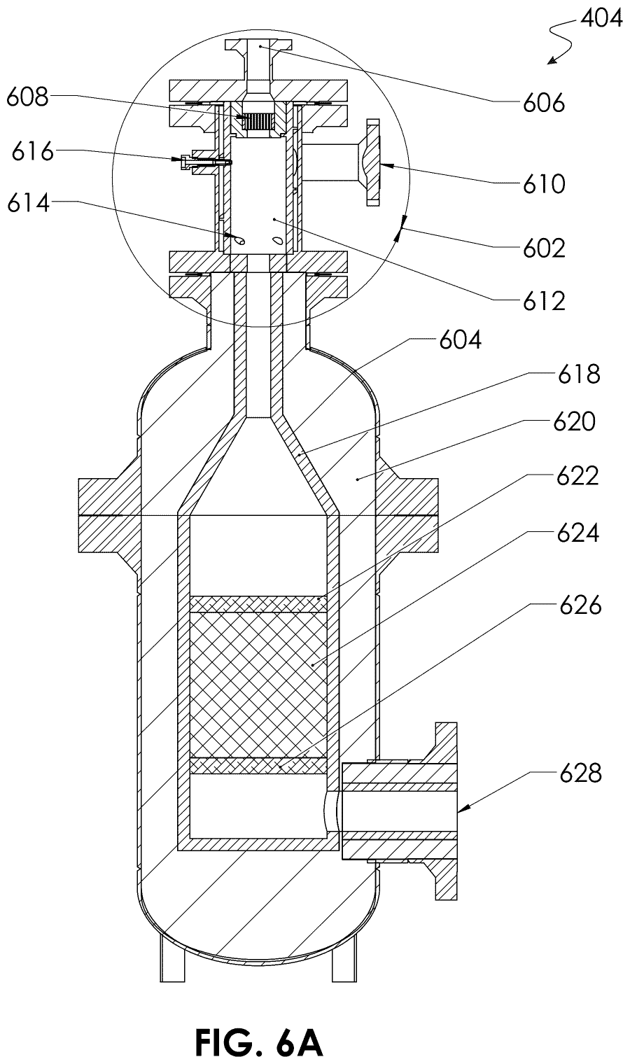

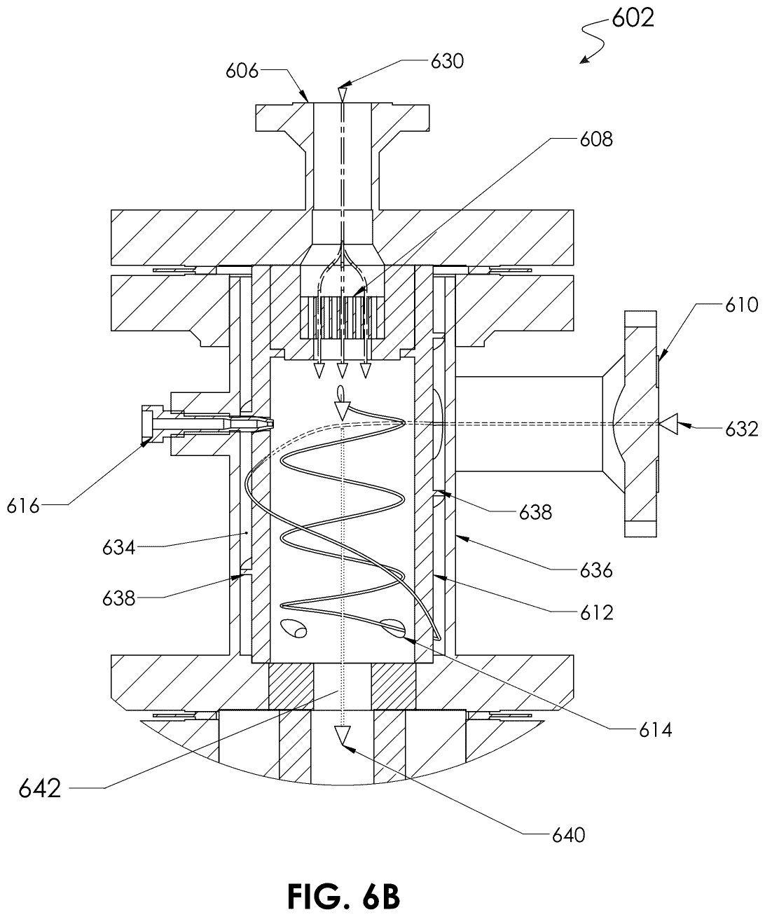

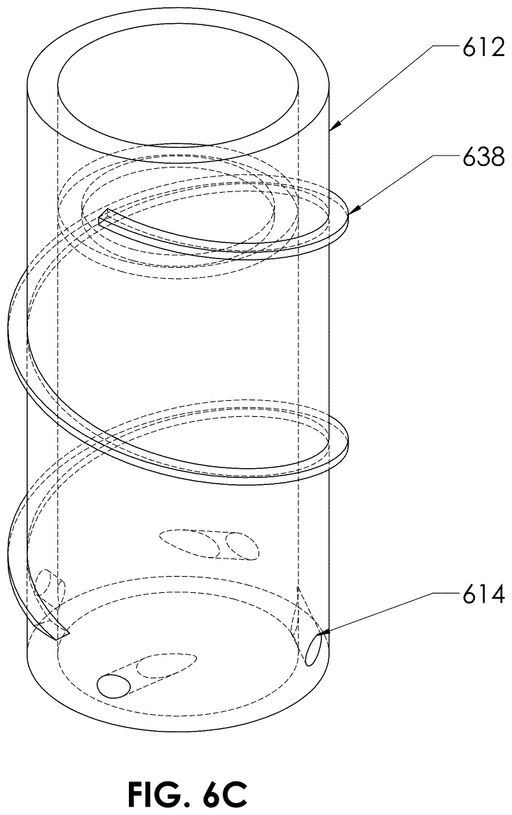

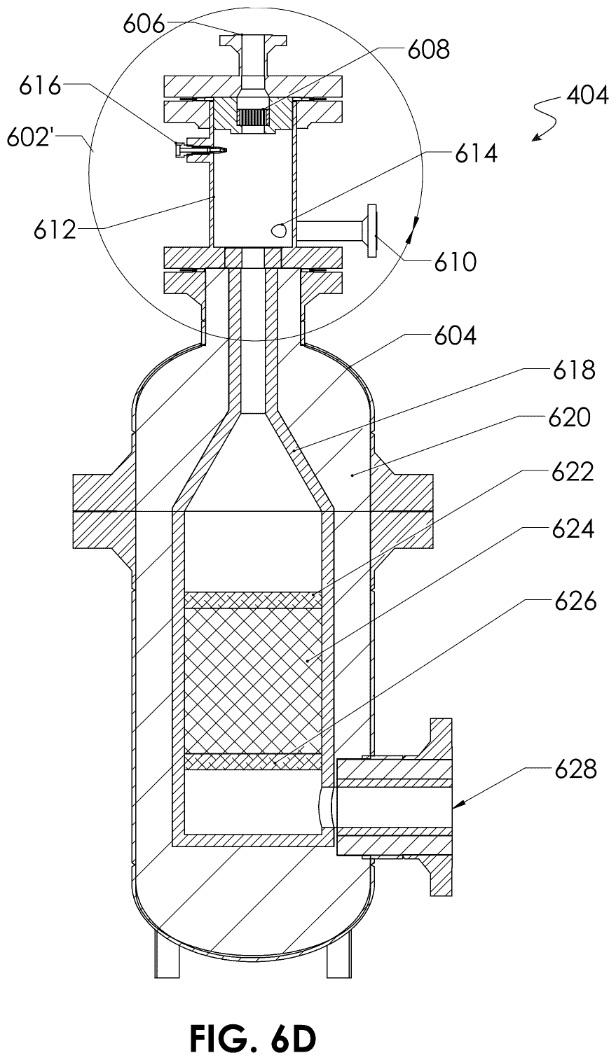

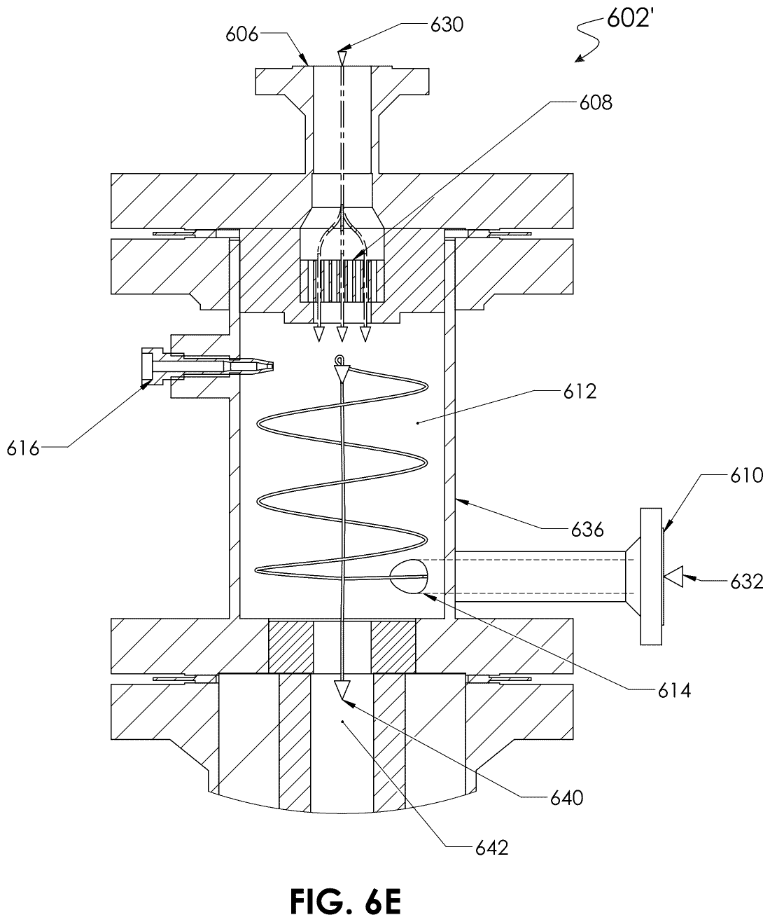

FIG. 4B is a top view of the portable GTL plant 302 in the folded position. Like numbered items are as described with respect to FIG. 3. Further items are visible in the top view, including air coolers 402 and the reformer 404 (reforming reactor system 114). The reformer 404 is discussed further with respect to FIG. 6A-6C. A VPSA vacuum blower 406 (air separation system 116) is used to provide the vacuum to the VPSA adsorption vessels 320 for regeneration, e.g., pulling a vacuum on the VPSA adsorption vessels 320 during a regeneration cycle to remove nitrogen and other components of the air. A VPSA vacuum silencer 324 acts as a muffler to lower the sound from the VPSA vacuum blower 406.

A high-temperature product separator 408 (separation system 138) is visible in the hinged structure 308. The high-temperature product separator 408 is used to separate products coming from the FT reactor 310 prior to pumping the lower molecular weight products to the distillation column 312.

FIG. 4C is a front view of the portable GTL plant 302 in the folded position. Like numbered items are as described with respect to FIG. 3. In this view, the bottom of the FT reactor 310 and the distillation column 312 are visible in the hinged structure 308. An FT water pump 410 (FT reactor system 134) is used to circulate cooling water through the FT reactor 310.

FIG. 4D is a back view of the portable GTL plant 302 in the folded position. In this view, the VPSA adsorption vessels 320, the VPSA heat exchanger 326, the VPSA blower silencer 322, and the VPSA intake filter 316 of the air separation system 116 are visible.

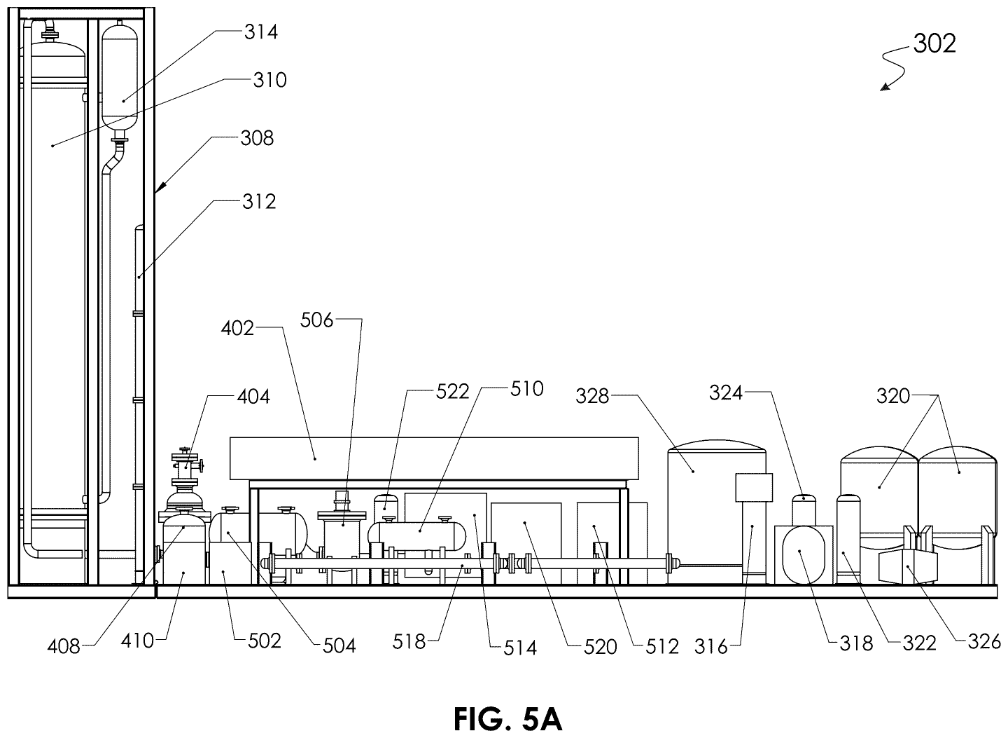

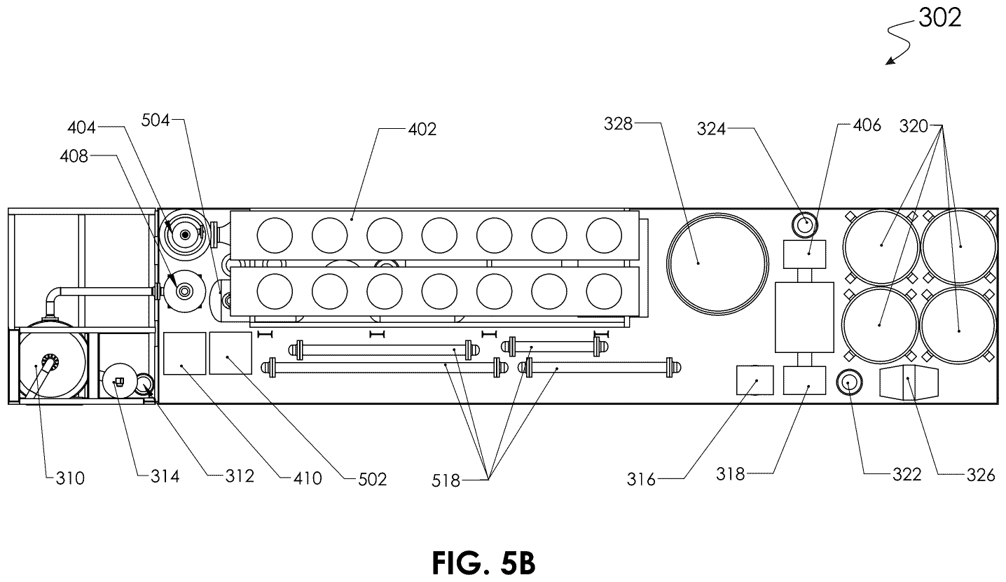

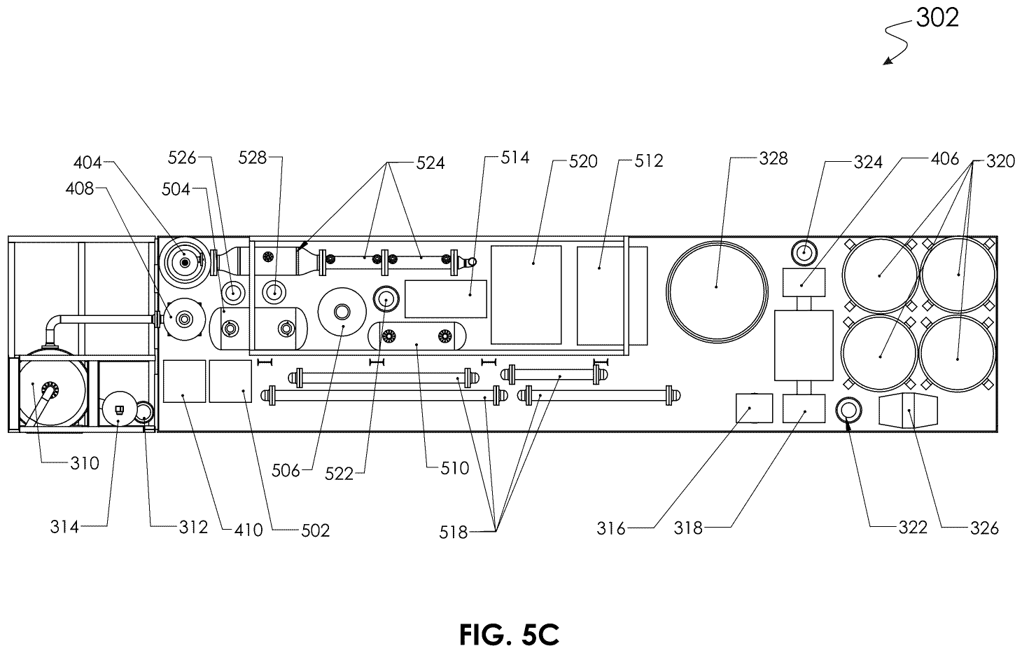

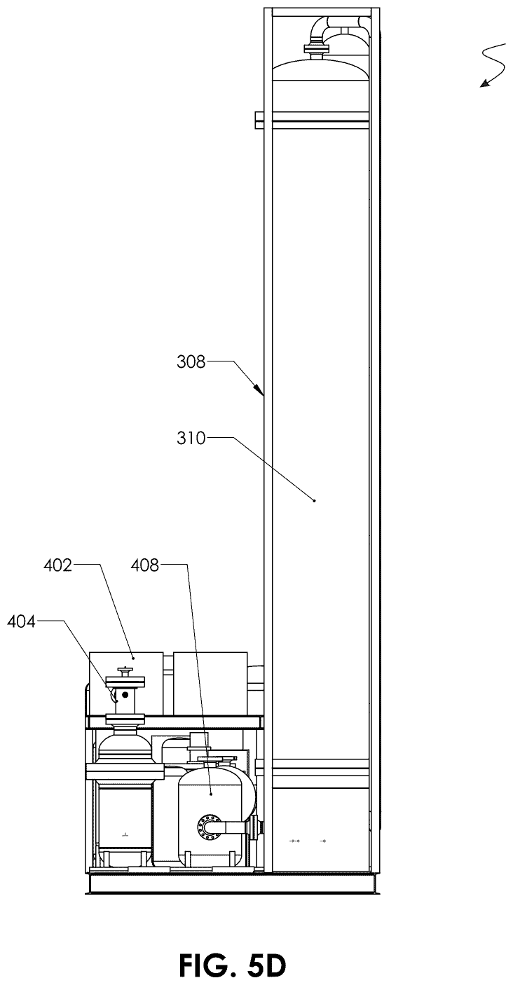

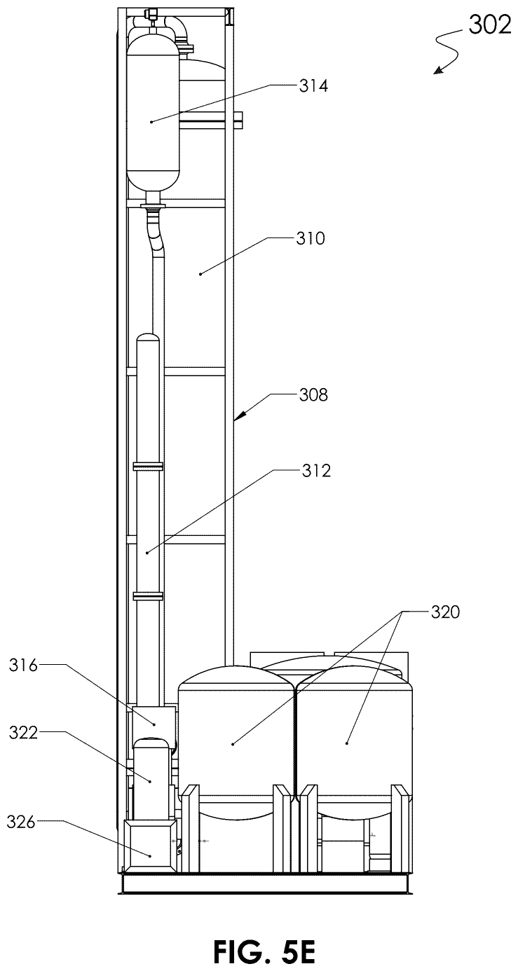

FIG. 5A is a side view of the portable GTL plant 302 in the open position. Like numbered items are as described with respect to the previous figures. In this view, the hinged structure 308 is rotated into an operational position, for example, substantially vertical with respect to gravitational forces. Other portions of the separation system 138, for example, a distillation pump 502 and a low-temperature product separator 504. From the high-temperature product separator 408, low molecular weight products are provided to a distillation pump 502, to be sent to the distillation column 312. From the high-temperature product separator 408, high molecular weight products are sent to a wax cracking reactor 506 (wax cracker 142). From the wax cracking reactor 506, the products are sent to a chain of wax cracker separators 508 and 510. Lower molecular weight products from the wax cracker separators 508 and 510 are returned to the distillation pump 502. The low-temperature product separator 504 is used to separate liquid products from gaseous products. In some embodiments, the total product stream from the FT reactor 310 is allowed to remain hot and provided to the distillation column 312. In some embodiments, the gaseous products are recirculated, and at least a portion is removed to control the build-up of inert gases. The gaseous products that are removed may be exported for use in other places, such as boilers, generators, and the like. In some embodiments, the removed gaseous products may be flared.

An oxygen compressor 512 (air separation system 116) is used to compress oxygen from the oxygen accumulator 328 and provide the oxygen to the reformer 404. As described with respect to FIGS. 1A and 1B, after cooling and water removal, at least a portion of the syngas generated in the reformer 404 is sent through a hydrogen membrane 514 (hydrogen separation membrane 128) where at least a portion of the hydrogen is separated from the syngas stream as a permeate stream. The remainder of the syngas is provided to the FT reactor 310. In the FT reactor 310 more complex carbon compounds are generated, for example, including compounds with about 3 to about 20 carbons. As the FT reaction is highly exothermic, the FT steam drum 314 is placed slightly above the FT reactor 310 to keep the cooling coils liquid full. The FT steam drum 314 also acts as a steam accumulator, providing steam to other portions of the process, along with steam generated during the cooling of the syngas from the reformer 404.

High-pressure steam (122) generated in the cooling of the syngas is used in a steam turbine generator 520 to generate power. Heat exchange units 518 are used to use waste heat from the high-temperature steam from the cooling of the syngas, low temperature steam released by the steam turbine generator 520, or both to provide heat to other portions of the process. For example, the waste heat may be used to heat the feed to the distillation column 312.

FIG. 5B is a top view of the portable GTL plant 302 in the open position. Like numbered items are as described with respect to previous figures. The air coolers 402 are coupled to a number of process units to remove waste heat that cannot be recovered for other uses.

FIG. 5C is a top view of the portable GTL plant 302 in the open position with the air coolers 402 removed to show units underneath. Units visible in this view include a syngas water knockout 522 (reforming reactor system 114), a heat recovery unit 524 (reforming reactor system 114), a first product flash drum 526 (separation system 138), and a second product flash drum 528 (separation system 138). The heat recovery unit 524 is used to cool the outlet from the reformer 404, generating the high-pressure steam 122 that can be used by the steam turbine generator 520. After passing through the heat recovery unit, the cooled syngas is fed to the syngas water knockout 522 to separate condensed water.

FIG. 5D is a front view of the portable GTL plant 302 in the open position. FIG. 5E is a back view of the portable GTL plant 302 in the open position. Like numbered items are as described with respect to previous figures. As shown in FIG. 5E, the FT steam drum 314 is placed at the top of the FT reactor 310, wherein the level of the catalyst in the tubes of the FT reactor 310 is below the level of liquid in the FT steam drum 314, keeping the cooling coils full of water during the FT reaction.

FIG. 6A is a cross-sectional view of the vortex-assisted reformer 404 from the reforming reactor system 114. The vortex-assisted reformer 404 includes a partial oxidation burner 602 placed with an outlet leading into a reforming chamber 604. The partial oxidation burner 602 includes an oxidizer inlet 606. The oxidizer, as described herein, can be oxygen from the air separation system 116 (FIGS. 1A and 1B), provided to the partial oxidation burner 602 from the oxygen compressor 512 (FIG. 5). The oxidizer is flowed through an inlet diffuser 608, which both distributes the oxidizer evenly and functions as a flashback arrestor, preventing a flame front from moving up into the oxidizer inlet 606.

The partial oxidation burner 602 has a feed inlet 610 to allow the feed stream 115 (FIGS. 1A and 1B) to be introduced into the partial oxidation burner 602. As described with respect to FIGS. 1A and 1B, the feed stream 115 is a mixture of the desulfurized stream 110 and steam 112. The feed stream 115 is flowed around the mixing chamber 612, cooling it and heating the feed stream 115. The feed stream 115 is then introduced into the mixing chamber 612 through tangential inlet ports 614, located at the bottom of the mixing chamber. As described further with respect to FIG. 6B, an igniter 616 is used to trigger a combustion reaction between the oxidizer and the feed stream.

The combustion is limited by the stoichiometry of the reactants, forming partially combusted gases. The partially combusted gases, including carbon monoxide, hydrogen, carbon dioxide, steam, oxygen, and low molecular weight hydrocarbons, such as methane, are fed to the reforming chamber 604. The reforming chamber 604 is lined with a high-density refractory layer 618, such as a layer of solid ceramic material. A low-density refractory layer 620 surrounds the high-density refractory layer 618. The low-density refractory layer 620 may be made from refractory ceramic fibers, for example, blended with inorganic binders to form a foam.

The reforming chamber 604 has a heat shield 622 to protect a catalyst bed 624. The heat shield 622 can be a metal mesh, a ceramic mesh, or ceramic balls, which distributes the heat across the top surface of the catalyst bed 624, preventing hotspots that may lead to sintering of the catalyst. A catalyst support 626 holds the catalyst bed 624 in the reforming chamber 604. The catalyst support 626 may also be a metal mesh, a ceramic mesh, ceramic balls, or other refractory material, with a finer size than the heat shield 622, to prevent the catalyst from being carried out of the reforming chamber 604.

In some embodiments, the reforming chamber 604 is operated free of a catalyst, and the partially combusted gases, including carbon monoxide, hydrogen, carbon dioxide, steam, oxygen, and low molecular weight hydrocarbons, such as methane, can be fed from the partial oxidation burner 602 to the reforming chamber 604.

In the reforming chamber 604, the partially combusted gases are further converted to syngas, including hydrogen and carbon monoxide. The syngas may have small amounts of other components, such as steam. The syngas exits the reforming chamber 604 through a syngas outlet 628. As described herein, the syngas may then be directed through the heat recovery unit 524 (FIG. 5C) for cooling, then to the syngas water knockout 522 to remove condensed water prior to passing at least a portion of the syngas through the hydrogen membrane 514.

FIG. 6B is a close-up cross-sectional view of the partial oxidation burner 602. In the close-up view of FIG. 6B, the flows of the reactants are shown in greater detail. The oxidizer stream 630 enters the partial oxidation burner 602 through the oxidizer inlet 606. It passes through the inlet diffuser 608 and is introduced into the mixing chamber 612.

The feed stream 632, including lower molecular weight hydrocarbons, such as methane, ethane, and the like, mixed with steam, is introduced into the partial oxidation burner 602 through the feed inlet 610. The feed stream 632 is fed into an annulus 634 between the outer casing 636 of the partial oxidation burner 602 and the mixing chamber 612. A spiral guide 638 directs the feed stream 632 in a spiral in the annulus 634 to the tangential inlet ports 614. This is discussed further with respect to FIG. 6C. The tangential inlet ports 614 are positioned to inject the feed stream 632 into the mixing chamber 612 along the walls of the mixing chamber 612, creating a spiral pattern or vortex around the inner surface of the wall, which flows back up the mixing chamber 612 towards the oxidizer inlet 606. At the top of the mixing chamber 612, the oxidizer stream 630 and the feed stream 632 are in fluid communication and are mixed. The igniter 616 can then be used to start the combustion. Once the combustion is underway, further energy input from the igniter 616 is not needed, and the igniter 616 may be powered off.

The spiral pattern of the feed stream 632 in the annulus 634 and the vortex along the inner surface of the mixing chamber 612 help to protect the mixing chamber 612 from damage due to the high combustion temperatures. At the top of the mixing chamber 612, the spiral flow increases the efficiency of mixing of the reactants. Further, the spiral flow in the annulus 634 heats the feed stream 632, which improves the efficiency of the combustion process. In some embodiments, the vortex flow of the feed stream 632 reverses direction when the feed stream 632 approaches the oxidizer inlet end of the mixing chamber 612, mixes with the oxidizer stream and produces a vortex in the reverse direction. This reverse vortex enhances mixing of the feed stream 632 and the oxidizer stream. The combustion products 640 are then fed to the reforming chamber 604 flowing axially through the center of the vortex, and exits through an exit port 642. The reaction begun in the mixing chamber 612 is continued in the reforming chamber 604.

FIG. 6C is a view of the mixing chamber 612 of the partial oxidation burner 602. This view shows the spiral guide 638 along the outside of the mixing chamber 612, leading to the tangential inlet ports 614.

FIG. 6D is a cross-sectional view of the vortex-assisted autothermal reformer 404 including a partial oxidation burner 602′ and the catalyst reforming vessel 604. The vortex-assisted reformer 404 includes the partial oxidation burner 602′ placed with an outlet leading into the reforming chamber 604. The partial oxidation burner 602′ includes an oxidizer inlet 606. The oxidizer, as described herein, can be oxygen from the air separation system 116 (FIGS. 1A and 1B), provided to the partial oxidation burner 602′ from the oxygen compressor 512 (FIG. 5). The oxidizer is flowed through an inlet diffuser 608, which both distributes the oxidizer evenly and functions as a flashback arrestor, preventing a flame front from moving up into the oxidizer inlet 606.

The partial oxidation burner 602′ has a feed inlet 610 to allow the feed stream 115 (FIGS. 1A and 1B) to be introduced into the partial oxidation burner 602′. As described with respect to FIGS. 1A and 1B, the feed stream 115 is a mixture of the desulfurized stream 110 and steam 112. The feed stream 115 is flowed into the mixing chamber 612 through tangential inlet ports 614, located at the bottom of the mixing chamber 612. As described further with respect to FIG. 6E, an igniter 616 is used to trigger a combustion reaction between the oxidizer and the feed stream.

The combustion is limited by the stoichiometry of the reactants, forming partially combusted gases. The partially combusted gases, including carbon monoxide, hydrogen, carbon dioxide, steam, oxygen, and low molecular weight hydrocarbons, such as methane, are fed to the reforming chamber 604, which is the same as the one shown in FIG. 6A.

FIG. 6E is a close-up cross-sectional view of the partial oxidation burner 602′. In the close-up view of FIG. 6E, the flows of the reactants are shown in greater detail. The oxidizer stream 630 can be preheated prior to entering the partial oxidation burner 602′, for example, by heat exchange with steam from the heat recovery unit 524 and/or resistive heating with power generated by the steam turbine generator 520. The oxidizer stream 630 enters the partial oxidation burner 602′ through the oxidizer inlet 606. It passes through the inlet diffuser 608 and is introduced into the mixing chamber 612.

The feed stream 632, including lower molecular weight hydrocarbons, such as methane, ethane, and the like, mixed with steam, is introduced into the partial oxidation burner 602′ through the feed inlet 610. The feed stream 632 can be preheated prior to entering the mixing chamber 612, for example, by heat exchange with steam from the heat recovery unit 524 and/or resistive heating with power generated by the steam turbine generator 520. The feed stream 632 is fed into the tangential inlet ports 614. The tangential inlet ports 614 are positioned to inject the feed stream 632 into the mixing chamber 612 along the walls of the mixing chamber 612, creating a spiral pattern along the inner surface, which flows back up the mixing chamber 612 towards the oxidizer inlet 606. At the top of the mixing chamber 612, the oxidizer stream 630 and the feed stream 632 are mixed. The igniter 616 can then be used to start the combustion. Once the combustion is underway, further energy input from the igniter 616 is not needed, and the igniter 616 may be powered off.

The spiral pattern of the feed stream 632 in vortex along the inner surface of the mixing chamber 612 helps to protect the mixing chamber 612 from damage due to the high combustion temperatures. At the top of the mixing chamber, the spiral flow increases the efficiency of mixing of the reactants. The combustion products 640 are then fed to the reforming chamber 604, flowing axially through the center of the vortex, and exiting through an exit port 642. The reaction begun in the mixing chamber 612 is continued in the reforming chamber 604.

FIG. 7 is a cross-sectional view of the FT reactor 310 showing the catalyst 702 in the tubes 704. In various embodiments, the FT reactor 310 is preloaded with the catalyst 702 prior to folding the hinged structure 308 closed, e.g., parallel to the skid unit 304, for shipping. To protect the catalyst 702 from vibration and settling, a first catalyst support 706 is placed at the bottom of the tubes 704 prior to loading the catalyst 702. In various embodiments, the first catalyst support 706 has three components, including a wire mesh support that holds the catalyst in the tubes during operation. The first catalyst support 706 also includes a catalyst retaining spring 708 to hold the catalyst in the tubes 704 and dampen vibrations on the catalyst 702 both during shipping and operations. The first catalyst support 706 can also include a wax component, such as a FT wax, which holds the catalyst 702 in place during shipping.

In various embodiments, a second catalyst support 710 is positioned at the top of each tube 704 to hold the catalyst in the tubes 704 during shipping in the horizontal position. As for the first catalyst support 706, the second catalyst support 710 can include an FT wax poured into the tubes on top of the catalyst before lowering the FT reactor 310 into the shipping position. In some embodiments, FT wax is introduced into the section between the first catalyst support 706 and the second catalyst support 710 filling the tube 704, and the FT wax encapsulates the catalyst 704, immobilizing the catalyst 704 and protecting catalyst 704 from vibrations that may occur during transport. During startup, heating of the FT reactor 310 can melt the FT wax, which will flow down through the catalyst 702 and exit the tubes 704.

During operation, syngas is introduced through an inlet 712 at the top of the FT reactor 310. The syngas flows through the catalyst 702, and more complex carbon compounds are formed by migratory insertion of carbon on the catalyst surface. The product and gases exit the FT reactor 310 through an outlet 714 at the bottom of the FT reactor 310.

The tubes 704 of the FT reactor 310 pass through an enclosure 716 formed by the wall 718 of the FT reactor 310. During operation, the enclosure 716 is filled with water for cooling. As described herein, a FT steam drum 314 is positioned wherein a level of water in the FT steam drum 314 is higher than the cooling outlet 720 from the FT reactor 310. Cooling water is introduced to the FT reactor through a cooling inlet 722 and is circulated by the FT water pump 410 (FIG. 4).

The use of the first catalyst support 706 and the second catalyst support 710 allow the FT reactor 310 to be shipped to an operational site, such as an oil or gas field, in a horizontal position. This lowers the costs, as servicing the FT reactor 310 at the operational site is not required. Further, the ability to ship the portable GTL plant 302 to a site reduces the cost of assembling a GTL plant at the site. Servicing the units offsite reduces the down time since a replacement unit can be installed as soon as the unit to be serviced is removed. This enables the capture of gaseous hydrocarbons without interruption and eliminates the need for redundant systems in the portable GTL plant 100 that would otherwise be required to prevent interruptions in production. This keeps the portable GTL plant 100 capital costs low and is an economic advantage over larger, custom-built, GTL plants.

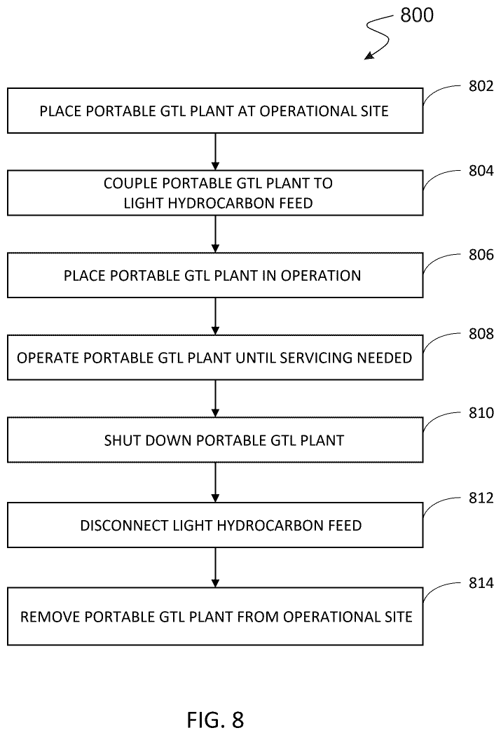

FIG. 8 is a process flow diagram of a method 800 for using a portable GTL plant (such as the portable GTL plant 100 or 302) at a field site. At block 802, the portable GTL plant is placed at an operational site (e.g., a stranded gas field or other source of light hydrocarbons, such as a gas producing field). For example, the portable GTL plant may be mounted on a skid that is transported by a trailer to the operational site. At the operational site, the portable GTL plant is offloaded from the trailer.

At block 804, the portable GTL plant is coupled to a light hydrocarbon feed (e.g., methane or other light hydrocarbon feed, such as natural gas which includes methane). For example, the light hydrocarbon feed may be a natural gas feed from a liquid gas separator. Depending on the production of liquid hydrocarbons that is desired, all or only a portion of the natural gas feed may be sent to the portable GTL plant at block 804. For example, another portion may be compressed and reinjected into the reservoir for enhanced oil recovery.

At block 806, the portable GTL plant is placed in operation to produce hydrocarbon liquids comprising about 3 carbon atoms (C3) to about 20 carbon atoms (C20). In some implementations, the portable GTL plant produces hydrocarbon liquids comprising about 3 carbon atoms (C3) to about 30 carbon atoms (C30). In some implementations, the portable GTL plant produces hydrocarbon liquids comprising about 6 carbon atoms (C6) to about 30 carbon atoms (C30).

At block 808, the portable GTL plant is operated until the portable GTL plant needs servicing. Operating the portable GTL plant at block 806 and 808 can include recovering waste heat and generating power from the recovered waste heat for facilitating operation of the portable GTL plant.

At block 810, the portable GTL plant is shut down. For example, shutting the portable GTL plant at block 810 includes closing in feed valves, allowing the portable GTL plant to cool, draining water from lines, and draining hydrocarbons from vessels and catalyst beds.

At block 812, the light hydrocarbon feed is disconnected from the portable GTL plant.

At block 814, the portable GTL plant is removed from the operational site. For example, a hinged structure that includes the FT reactor and the distillation column may be lowered to a horizontal position relative to the skid mount, and the skid mount is loaded onto a trailer to be taken back to a servicing facility for refurbishment. A replacement for the portable GTL plant may then be brought in and set in place, for example, returning to block 802.

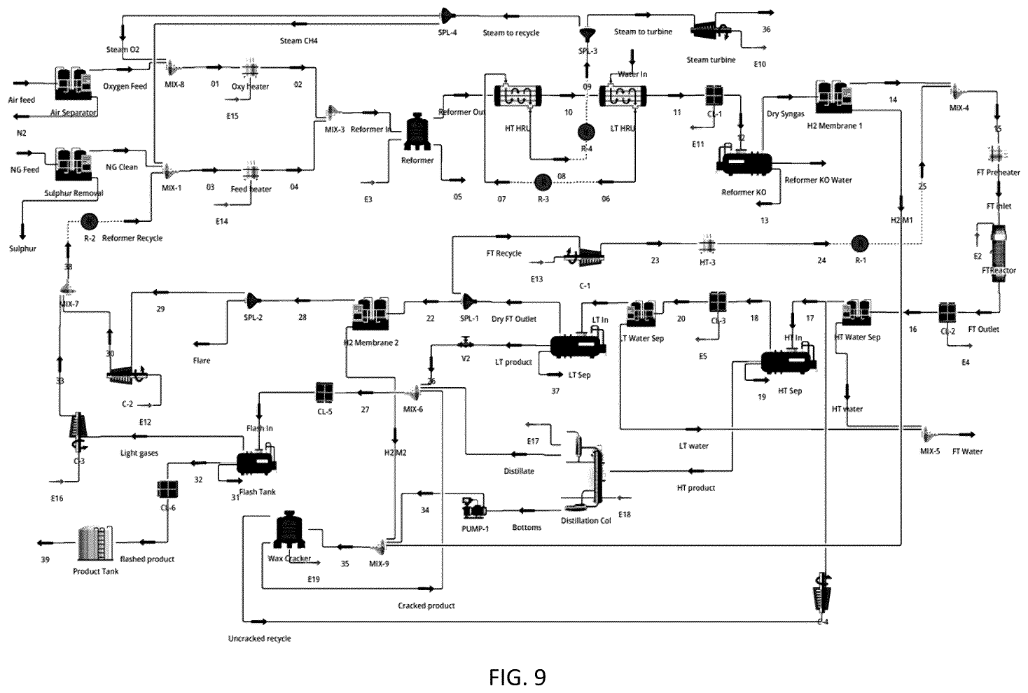

FIG. 9 is a process flow diagram (PFD) of an example simulation of a portable GTL plant (such as the portable GTL plant 100 or 302). The PFD shown in FIG. 9 is of a simulation made in DWSIM. An Air feed is an air stream that is fed to an Air Separator to separate nitrogen (N2) from the Air feed to form an Oxygen Feed stream (e.g., oxidizer stream) containing oxygen. Steam O2 is a steam stream that mixes with the Oxygen Feed to form Stream 01. Stream 01 is heated by an Oxy heater, which can be, for example, a heat exchanger. Stream 02 exiting the Oxy heater has the same composition as Stream 01 entering the Oxy heater, but at a hotter temperature.

An NG Feed is a natural gas stream that is fed to a Sulphur Removal unit to separate Sulphur (sulfur) from the NG Feed to form an NG Clean stream (e.g., light hydrocarbon feedstock) that includes light hydrocarbon(s) (e.g., methane) and is substantially free of sulfur. Reformer Recycle stream (e.g., reformer recycle stream 145) is a recycle stream. Steam CH4 is a steam stream. Reformer Recycle stream and Steam CH4 mix with the NG Clean stream to form Stream 03. Stream 03 is heated by a Feed heater, which can be, for example, a heat exchanger. Stream 04 exiting the Feed heater has the same composition as Stream 03 entering the Feed heater, but at a hotter temperature. Stream 02 and Stream 04 mix to form a Reformer In stream, which is the process stream that is fed to a Reformer (e.g., reformer 404). The Reformer In stream is at least partially oxidized in the Reformer to produce a Reformer Out stream, which is a process stream that includes syngas.

The Reformer Out stream is cooled by a High Temperature Heat Recovery Unit (HRU) by heat exchange with Stream 07, which is a utility stream including water (e.g., in the form of liquid water, steam, or both). Stream 10 exiting the HT HRU has the same composition as the Reformer Out stream entering the HT HRU, but at a cooler temperature. Stream 08 exiting the HT HRU has the same composition as Stream 07 entering the HT HRU, but with a higher vapor content (e.g., higher steam quality by evaporation). A first portion of Stream 08 is provided as feed to the Reformer via the Steam O2 stream (mixed with Oxygen Feed). A second portion of Stream 08 is provided as feed to the Reformer via the Steam CH4 stream (mixed with NG Clean stream and Reformer Recycle stream).

Stream 10 is further cooled by a Low Temperature Heat Recovery Unit (LT HRU) by heat exchange with a Water In stream, which is a utility stream including water (e.g., in the form of liquid water). Stream 11 exiting the LT HRU has the same composition as Stream 10 entering the LT HRU, but at a cooler temperature. Stream 06 exiting the LT HRU has the same composition as the Water In stream entering the LT HRU, but at a hotter temperature or a higher vapor content (evaporation). Stream 06 and Stream 07 are the same but are distinguished in the simulation for executing a recycle block (R-3).

Stream 11 is further cooled by a cooler (CL-1). Stream 12 exiting CL-1 has the same composition as Stream 11 entering CL-1, but at a cooler temperature or lower vapor content (e.g., more liquid content by condensation). Stream 12 is fed to a Reformer KO (knockout drum), which separates Dry Syngas from Stream 12. The Dry Syngas stream includes syngas and is substantially free of water. The Dry Syngas stream is a vapor. The Dry Syngas stream is fed to an H2 Membrane 1 unit, which is a separation unit including a membrane for separating a portion of the hydrogen from the Dry Syngas stream to adjust the hydrogen to carbon monoxide ratio. The hydrogen separated from the Dry Syngas stream is stream H2 M1 exiting the H2 Membrane 1 unit. Stream 14 exiting the H2 Membrane 1 unit is a remaining portion of the Dry Syngas. Stream 14 includes carbon monoxide, carbon dioxide, and hydrogen.

Stream 25 is a recycle stream that mixes with Stream 14 to form Stream 15. Stream 15 is fed to a Fischer-Tropsch (FT) Preheater. Stream 15 is heated by the FT Preheater to form an FT Inlet stream. The FT Inlet stream exiting the FT Preheater has the same composition as Stream 15 entering the FT Preheater, but at a hotter temperature. The FT Inlet stream is processed by an FT Reactor to form an FT Outlet stream. The FT Reactor performs FT reactions to convert carbon monoxide and hydrogen into hydrocarbons, including liquid hydrocarbons. The FT Outlet stream includes liquid hydrocarbons and light hydrocarbons.

The FT Outlet stream is fed to a cooler (CL-2). The FT Outlet stream is cooled by CL-2 to form Stream 16. Stream 16 exiting CL-2 has the same composition as the FT Outlet stream entering CL-2, but at a cooler temperature. Stream 16 is fed to a High Temperature Water Separator (HT Water Sep). The HT Water Sep separates water from Stream 16 to form an HT Water stream and Stream 17. The HT Water stream includes water that has been separated from Stream 16. Stream 17 includes a remaining portion of Stream 16 after the HT Water stream has been separated by the HT Water Sep.

An Uncracked Recycle stream is a process stream that mixes with Stream 17 to form HT In stream. The HT In stream is fed to a High Temperature Separator (HT Sep). The HT Sep separates an HT Product stream and Stream 18 from the HT In stream. The HT Product stream includes liquid hydrocarbons. Stream 18 includes light hydrocarbons, non-condensables, and water vapor.

Stream 18 is fed to a cooler (CL-3). CL-3 cools Stream 18 to form Stream 20. Stream 20 exiting CL-3 has the same composition as Stream 18 entering CL-3, but at a cooler temperature or higher liquid content (condensation). Stream 20 is fed to a Low Temperature Water Separator (LT Water Sep). LT Water Sep separates LT Water from Stream 20. LT Water includes water that has been separated from Stream 20 by the LT Water Sep. The LT In stream is a remaining portion of Stream 20, after water has been separated by the LT Water Sep.

The LT In stream is fed to a Low Temperature Separator (LT Sep). The LT Sep separates an LT Product stream and a Dry FT Outlet stream from the LT In stream. The LT Product stream includes a liquid hydrocarbon portion of the LT In stream. The Dry FT Outlet stream includes a vapor portion of the LT In stream. A first portion of the Dry FT Outlet is recycled as FT Recycle stream to the FT Reactor (as Stream 25, which is compressed, heated, and mixed with Stream 14). A second portion of the Dry FT Outlet is fed to an H2 Membrane 2 unit as Stream 22.

H2 Membrane 2 unit is a separation unit including a membrane for separating hydrogen from Stream 22. The hydrogen separated from Stream 22 is stream H2 M1 exiting the H2 Membrane 2 unit. Stream 28 exiting the H2 Membrane 2 unit is a remaining portion of Stream 22. A first portion of Stream 28 is sent to a flare as Flare stream for burning. A second portion of Stream 28 is recycled to the Reformer (as Stream 29, which is compressed mixed with NG Clean prior to being recycled to the Reformer).

The HT product stream from the HT Sep unit is fed to a Distillation Column (Distillation Col). Heat is provided to the bottom of the Distillation Col, while heat is removed from the top of the Distillation Col. The Distillation Col fractionates the HT product stream to produce a Bottoms stream and a Distillate stream. The Bottoms stream includes a heavy fraction of the HT product stream. The Distillate stream includes a remaining, light fraction of the HT product stream.

The Bottoms stream is mixed with the H2 M1 stream and the H2 M2 stream to form Stream 35. Stream 35 is fed to a Wax Cracker. The Wax Cracker breaks carbon-carbon bonds to convert higher molecular weight hydrocarbons into lower molecular weight hydrocarbons. The Wax Cracker produces a Cracked product stream which includes the portion of Stream 35 that has been cracked by the Wax Cracker. The Uncracked recycle stream is a remaining portion of Stream 35 that remains uncracked by the Wax Cracker. The Uncracked recycle stream is expanded and recycled to the HT Sep with Stream 17.

The Cracked product from the Wax Cracker, the Distillate stream from the Distillation Col, and the LT product stream from the LT Sep are mixed to form Stream 27. Stream 27 is fed to a cooler (CL-5). CL-5 cools Stream 27 to form a Flash In stream. The Flash In stream exiting CL-5 has the same composition as Stream 27 entering CL-5, but at a cooler temperature or higher liquid content (condensation). The Flash In stream is fed to Flash Tank, which is a separator. The Flash Tank separates a Light gases stream and Stream 32 from the Flash In stream. The Light gases stream includes a vapor portion of the Flash In stream. The Light gases stream is compressed and recycled to the Reformer (as Stream 33, which is mixed with NG Clean prior to being recycled to the Reformer).

Stream 32 includes liquid hydrocarbons. Stream 32 exiting the Flash Tank is fed to a cooler (CL-6). CL-6 cools Stream 32 to form a flashed product stream. The flashed product stream exiting CL-6 has the same composition as Stream 32 entering CL-6, but at a cooler temperature (e.g., subcooled) or higher liquid content (condensation). The flashed product is sent to a Product Tank for storage.

Table 1 provides process data for a few process streams of the simulation whose PFD is shown in FIG. 9. It is noted that the data shown in Table 1 is specific for the example simulation, and other simulations using different process packages and vapor-liquid models may result in varying process data. The data shown in Table 1 is simply presented to exhibit the success in converting light hydrocarbon(s) into heavier, liquid hydrocarbons of a particular simulated implementation of the portable GTL plant described.

TABLE 1
Process Stream Data for Example Simulation

| | Stream | | | |
|---|---|---|---|---|
| | | | Dry FT | Flashed |
| Component | FT Inlet | FT Outlet | Outlet | Product |
| Hydrogen | 40.147% | 26.024% | 29.266% | .007% |
| Water | 0.066% | 10.323% | 0.001% | 0.000% |
| Nitrogen | 8.067% | 9.719% | 10.928% | 0.006% |
| Argon | 4.839% | 5.830% | 6.554% | 0.008% |
| Carbon monoxide | 21.716% | 15.921% | 17.901% | 0.012% |
| Carbon dioxide | 16.334% | 19.680% | 22.064% | 0.439% |
| C5+ | 0.391% | 1.203% | 0.624% | 98.19% |
| C2-C29 | 1.822% | 3.25% | 2.886% | 99.527% |
| Normalized C5+ | | | | 98.656% |
| Normalized C8-C20 | | | | 68.050% |
| Normalized C21-C29 | | | | 12.77% |
| Flow rate (lb/min) | 426.34 | 426.34 | 373.20 | 19.20 |

In some embodiments, the portable GTL plants are kept small to make them easily transportable. The designs of the small GTL plants can be standardized to allow mass production and easy interchangeability when the units are picked up for servicing offsite. Small plants are counter intuitive in the art and many operators tend towards larger plant sizes since the capital investment per unit volume of product for these larger plants improves as the size increases. The designs discussed herein are directed to portability and lower capital costs. For example, the designs can be used to create a group or “fleet” of similar, transportable plants that can be put in operation in separate fields and picked up to be serviced remotely. The designs discussed herein can be standardized and their smaller size and higher production volume in comparison to conventional GTL systems allow for mass production of the portable GTL plants and their components. Standardizing the design of the units allows for standardized components that are common to the other units with the same standardized design. Mass production of these units and their components allows for significant reduction of manufacturing costs and allows the engineering to be amortized over many units.

Some embodiments include the production of a plurality of mass produced units, comprising a group, for producing hydrocarbon liquids in the range of C6 to C30 from a source of light hydrocarbons. Each unit is portable over normal roads and each unit comprises standardized components common to the other units in the group. Each unit is installable at a production location with limited site prep and each unit can be easily connected and disconnected from the source of light hydrocarbons. Each unit is transportable to an off-site service location and comprises catalysts. In some embodiments, the catalysts in each unit are configured for transport without removal.

Some embodiments comprise a method for producing hydrocarbon liquids from a source of light hydrocarbons the method comprising: designing a portable chemical plant to be mass produced having a standard design; producing more than one portable chemical plant to create a group of chemical plants having the standard design; placing one of the portable chemical plants from the group at a production location having access to hydrocarbon feed stock; operating the portable chemical plant remotely without local human assistance; retrieving the portable chemical plant when it is in need of service; servicing the portable chemical plant at a location different from the production location; and returning the portable chemical plant to a production location having access to hydrocarbon feed stock.

For scaling, multiple units can be installed at a site instead of a single fixed unit. The number of units installed are selected to handle the volume of feedstock available. Installation in the field for operation requires little to no site-prep as the skid mount can be placed directly on the ground. The standardization of the GTL plants allows economies of scale to be realized in production and reducing unit capital costs. The smaller plants can be shut down with minor impact on production if they experience operational problems. Large, fixed units are forced to build in redundancy to mitigate the enormous cost of shut down of the entire plant. By comparison, the shut-down of a single small plant has a minor impact on production.

Further, the fleet of small, transportable units allows the plants to be built with minimal redundancy of process components. The reduction of redundant components further reduces the capital cost of the units. As the smaller units can be operated autonomously and do not require on-site personnel, the economics are further improved. The elimination of the need for redundant equipment reduces the overall plant cost and simplifies the maintenance. The operation of a fleet of small units also has minimal production risks since the entire production of the site depends upon multiple units and not a single large unit and one unit going down has a small effect on the total production.

### EMBODIMENTS

In an example implementation (or aspect), a portable gas-to-liquids (GTL) plant for producing a liquid hydrocarbon from a gaseous hydrocarbon feed, comprises: a reforming reactor to form a syngas from a desulfurized hydrocarbon stream and an oxidizer stream; and a Fischer-Tropsch reactor to form a hydrocarbon outlet stream from the syngas, wherein the hydrocarbon outlet stream comprises carbon compounds of about eight to about 20 carbons, wherein the Fischer-Tropsch reactor comprises a rotatable tower comprising a catalyst, and wherein the rotatable tower comprising the catalyst is in a horizontal position during shipping and the rotatable tower comprising the catalyst is in a vertical position during operation.

In an example implementation (or aspect) combinable with any example implementation (or aspect), the portable GTL plant comprises a separation system comprising a separation column to isolate a liquid hydrocarbon stream from a wax stream.

In an example implementation (or aspect) combinable with any example implementation (or aspect), the portable GTL plant comprises a wax cracker to crack the wax into carbon compounds of about 8 to about 20 carbons.

In an example implementation (or aspect) combinable with any example implementation (or aspect), the portable GTL plant comprises a hydrogen separation membrane configured to separate a portion of the hydrogen from the syngas to form a hydrogen depleted stream.

In an example implementation (or aspect) combinable with any example implementation (or aspect), the Fischer-Tropsch reactor is configured to form the hydrocarbon outlet stream from the hydrogen depleted stream.

In an example implementation (or aspect) combinable with any other example implementation (or aspect), the portable GTL plant comprises a skid mount base configured to be placed on a tractor trailer.

In an example implementation (or aspect) combinable with any other example implementation (or aspect), the portable GTL plant comprises a desulfurization unit to form the desulfurized hydrocarbon stream from the gaseous hydrocarbon feed.

In an example implementation (or aspect) combinable with any other example implementation (or aspect), the desulfurization unit comprises a hydrogen feed and a catalyst.

In an example implementation (or aspect) combinable with any other example implementation (or aspect), the catalyst comprises a cobalt-promoted molybdenum catalyst (Co—Mo), comprising a mixture of MoS₂ and Co₉S₈ supported on alumina.

In an example implementation (or aspect) combinable with any other example implementation (or aspect), the reforming reactor comprises a partial oxidation burner and a reformer chamber.

In an example implementation (or aspect) combinable with any other example implementation (or aspect), the partial oxidation burner comprises an oxidizer inlet for the oxidizer stream.

In an example implementation (or aspect) combinable with any other example implementation (or aspect), the partial oxidation burner comprises an outer enclosure.

In an example implementation (or aspect) combinable with any other example implementation (or aspect), the partial oxidation burner comprises an inner mixing chamber.

In an example implementation (or aspect) combinable with any other example implementation (or aspect), the partial oxidation burner comprises a diffuser block disposed after the oxidizer inlet in the oxidizer stream.

In an example implementation (or aspect) combinable with any other example implementation (or aspect), the diffuser block prevents flashback from the partial oxidation burner into the oxidizer inlet.

In an example implementation (or aspect) combinable with any other example implementation (or aspect), the partial oxidation burner comprises a hollow annulus between the outer enclosure and the inner mixing chamber.

In an example implementation (or aspect) combinable with any other example implementation (or aspect), the partial oxidation burner comprises a feed inlet for the desulfurized hydrocarbon stream.

In an example implementation (or aspect) combinable with any other example implementation (or aspect), the feed inlet is disposed in an upper portion of the hollow annulus.

In an example implementation (or aspect) combinable with any other example implementation (or aspect), the desulfurized hydrocarbon stream is directed in a spiral around the inner mixing chamber.

In an example implementation (or aspect) combinable with any other example implementation (or aspect), the desulfurized hydrocarbon stream is introduced into the mixing chamber through ports disposed in a lower portion of the hollow annulus.

In an example implementation (or aspect) combinable with any other example implementation (or aspect), the partial oxidation burner comprises an igniter disposed in an upper portion of the mixing chamber.

In an example implementation (or aspect) combinable with any other example implementation (or aspect), the igniter initiates a partial oxidation reaction between the oxidizer stream and the desulfurized hydrocarbon stream.

In an example implementation (or aspect) combinable with any other example implementation (or aspect), the oxidizer stream comprises oxygen and steam.

In an example implementation (or aspect) combinable with any other example implementation (or aspect), the oxidizer stream comprises steam.

In an example implementation (or aspect) combinable with any other example implementation (or aspect), the reforming reactor comprises an autothermal reformer.

In an example implementation (or aspect) combinable with any other example implementation (or aspect), the reforming reactor comprises a steam methane reformer.

In an example implementation (or aspect) combinable with any other example implementation (or aspect), an outlet of the mixing chamber is coupled to an inlet of the reformer chamber.

In an example implementation (or aspect) combinable with any other example implementation (or aspect), combustion products from the mixing chamber are fed to the reformer chamber.

In an example implementation (or aspect) combinable with any other example implementation (or aspect), wherein combustion products from the mixing chamber are fed to the reformer chamber.

In an example implementation (or aspect) combinable with any other example implementation (or aspect), the reformer chamber comprises a reforming catalyst.

In an example implementation (or aspect) combinable with any other example implementation (or aspect), the reforming catalyst comprises nickel metal supported on alumina.

In an example implementation (or aspect) combinable with any other example implementation (or aspect), the hydrogen separation membrane comprises a metal membrane.

In an example implementation (or aspect) combinable with any other example implementation (or aspect), the hydrogen separation membrane comprises platinum.

In an example implementation (or aspect) combinable with any other example implementation (or aspect), the hydrogen separation membrane comprises a polymer.

In an example implementation (or aspect) combinable with any other example implementation (or aspect), the portable GTL plant comprises a heat recovery steam generator to generate a steam stream.

In an example implementation (or aspect) combinable with any other example implementation (or aspect), the portable GTL plant comprises a steam turbine generator.

In an example implementation (or aspect) combinable with any other example implementation (or aspect), the portable GTL plant comprises an air separation system to separate oxygen from air.

In an example implementation (or aspect) combinable with any other example implementation (or aspect), the oxidizer stream comprises the oxygen.

In an example implementation (or aspect) combinable with any other example implementation (or aspect), the air separation system comprises a pressure swing absorbance system.

In an example implementation (or aspect) combinable with any other example implementation (or aspect), the air separation system comprises a cryogenic separator.

In an example implementation (or aspect), a method for producing liquid hydrocarbons from a methane feed in a portable GTL plant comprises: placing the portable GTL plant at an operational site; coupling the portable GTL plant to a natural gas feed; coupling the portable GTL plant to utilities; placing the portable GTL plant in operation to produce hydrocarbon liquids comprising about 3 to about 20 carbon atoms; operating the portable GTL plant until servicing is needed; shutting the portable GTL plant down; disconnecting the methane feed; disconnecting the utilities; and removing the portable GTL plant from the operational site.

In an example implementation (or aspect) combinable with any other example implementation (or aspect), the method comprises raising a Fischer-Tropsch reactor that comprises a rotatable tower to a vertical position for operations, wherein the Fischer-Tropsch reactor comprises a preloaded catalyst.

In an example implementation (or aspect) combinable with any other example implementation (or aspect), the method comprises lowering the Fischer-Tropsch reactor to a horizontal position for shipping.

In an example implementation (or aspect) combinable with any other example implementation (or aspect), the operational site comprises an oilfield comprising coproduced natural gas.

In an example implementation (or aspect) combinable with any other example implementation (or aspect), the operational site comprises an oilfield comprising dry natural gas.

In an example implementation (or aspect) combinable with any other example implementation (or aspect), the operational site comprises stranded natural gas.

In an example implementation (or aspect) combinable with any other example implementation (or aspect), the utilities comprise electric power.

In an example implementation (or aspect) combinable with any other example implementation (or aspect), the utilities comprise a water feed.

In an example implementation (or aspect), a reforming reactor comprises: a partial oxidation burner, comprising: a mixing chamber comprising a flame; a vessel wall disposed around the mixing chamber, forming an annulus, wherein a feed stream is injected into the annulus, and is heated by conductive heat from the flame, wherein the feed stream is introduced into the mixing chamber through inlet ports disposed in a lower region of the partial oxidation burner; and a reforming chamber disposed at an outlet of the partial oxidation burner, wherein the reforming chamber comprises a syngas catalyst.

In an example implementation (or aspect), a portable GTL plant for producing a liquid hydrocarbon from a gaseous hydrocarbon feed comprises: a reforming reactor to form a syngas from an oxidizer stream and the gaseous hydrocarbon feed; a hydrogen separation membrane to separate a portion of the hydrogen from the syngas, forming a hydrogen depleted stream; a Fischer-Tropsch reactor to form a hydrocarbon outlet stream from the hydrogen depleted stream, wherein the hydrocarbon outlet stream comprises carbon compounds of about eight to about 20 carbons, wherein the Fischer-Tropsch reactor comprises a rotatable tower comprising a preloaded catalyst disposed within the Fischer-Tropsch reactor, and wherein the rotatable tower comprising the catalyst is in a horizontal position during shipping and the rotatable tower comprising the catalyst is in a vertical position during operation; a separation system configured to receive the hydrocarbon outlet stream from the Fischer-Tropsch reactor, wherein the separation system comprises a separation column to separate the hydrocarbon outlet stream into a liquid hydrocarbon stream and a wax stream; and a wax cracker to crack the wax stream into carbon compounds of about 8 to about 20 carbons.

In an example implementation (or aspect) combinable with any other example implementation (or aspect), the portable GTL plant comprises a skid mount base configured to be placed on a tractor trailer.

In an example implementation (or aspect) combinable with any other example implementation (or aspect), the portable GTL plant comprises a desulfurization unit comprising a desulfurization catalyst to form the gaseous hydrocarbon feed.

In an example implementation (or aspect) combinable with any other example implementation (or aspect), the gaseous hydrocarbon feed is substantially free of sulfur.

In an example implementation (or aspect) combinable with any other example implementation (or aspect), the portable GTL plant comprises an air separation unit configured to separate oxygen from air to form the oxidizer stream.

In an example implementation (or aspect) combinable with any other example implementation (or aspect), the portable GTL plant comprises a recycle line configured to recycle at least a portion of the hydrocarbon outlet stream to mix with the hydrogen depleted stream entering the Fischer-Tropsch reactor.

In an example implementation (or aspect) combinable with any other example implementation (or aspect), the reforming reactor is a vortex-assisted autothermal reforming reactor comprising a partial oxidation burner and a reformer chamber.

In an example implementation (or aspect) combinable with any other example implementation (or aspect), the partial oxidation burner comprises an oxidizer inlet for the oxidizer stream.

In an example implementation (or aspect) combinable with any other example implementation (or aspect), the partial oxidation burner comprises an outer enclosure.

In an example implementation (or aspect) combinable with any other example implementation (or aspect), the partial oxidation burner comprises an inner mixing chamber.

In an example implementation (or aspect) combinable with any other example implementation (or aspect), the portable GTL plant comprises a diffuser block disposed after the oxidizer inlet in the oxidizer stream.

In an example implementation (or aspect) combinable with any other example implementation (or aspect), the diffuser block prevents flashback from the partial oxidation burner into the oxidizer inlet.

In an example implementation (or aspect) combinable with any other example implementation (or aspect), the vortex-assisted autothermal reforming reactor comprises a hollow annulus between the outer enclosure and the inner mixing chamber.

In an example implementation (or aspect) combinable with any other example implementation (or aspect), the vortex-assisted autothermal reforming reactor comprises a feed inlet for the desulfurized hydrocarbon stream.

In an example implementation (or aspect) combinable with any other example implementation (or aspect), the feed inlet is disposed in an upper portion of the hollow annulus.

In an example implementation (or aspect) combinable with any other example implementation (or aspect), the desulfurized hydrocarbon stream is directed in a spiral around the inner mixing chamber.

In an example implementation (or aspect) combinable with any other example implementation (or aspect), the desulfurized hydrocarbon stream is introduced into the mixing chamber through ports disposed in a lower portion of the hollow annulus.

In an example implementation (or aspect) combinable with any other example implementation (or aspect), the vortex-assisted autothermal reforming reactor comprises an igniter disposed in an upper portion of the mixing chamber.

In an example implementation (or aspect) combinable with any other example implementation (or aspect), the igniter initiates a partial oxidation reaction between the oxidizer stream and the desulfurized hydrocarbon stream.

In an example implementation (or aspect) combinable with any other example implementation (or aspect), the oxidizer stream comprises oxygen and steam.

In an example implementation (or aspect) combinable with any other example implementation (or aspect), an outlet of the mixing chamber is coupled to an inlet of the reformer chamber.

In an example implementation (or aspect) combinable with any other example implementation (or aspect), combustion products from the mixing chamber are fed to the reformer chamber.

In an example implementation (or aspect) combinable with any other example implementation (or aspect), the reformer chamber comprises a reforming catalyst.

In an example implementation (or aspect) combinable with any other example implementation (or aspect), the reforming catalyst comprises nickel metal supported on alumina.

In an example implementation (or aspect) combinable with any other example implementation (or aspect), the hydrogen separation membrane comprises platinum.

In an example implementation (or aspect) combinable with any other example implementation (or aspect), the hydrogen separation membrane comprises a polymer.

In an example implementation (or aspect) combinable with any other example implementation (or aspect), the portable GTL plant comprises a heat recovery steam generator to generate a steam stream.

In an example implementation (or aspect) combinable with any other example implementation (or aspect), the portable GTL plant comprises a steam turbine generator.

In an example implementation (or aspect), a method for producing liquid hydrocarbons from a light hydrocarbon feed in a portable GTL plant comprises: placing the portable GTL plant at an operational site, wherein the portable GTL plant comprises a Fischer-Tropsch reactor comprising a preloaded catalyst for forming a hydrocarbon outlet stream from a light hydrocarbon feed, wherein the preloaded catalyst is disposed within the Fischer-Tropsch reactor while the portable GTL plant is placed at the operational site; coupling the portable GTL plant to the light hydrocarbon feed; placing the portable GTL plant in operation to produce hydrocarbon liquids comprising about 3 to about 20 carbon atoms; operating the portable GTL plant until servicing is needed; shutting the portable GTL plant down; disconnecting the light hydrocarbon feed; and removing the portable GTL plant from the operational site.

In an example implementation (or aspect) combinable with any example implementation (or aspect), the method comprises recovering waste heat and generating power from the recovered waste heat for facilitating operation of the portable GTL plant.

In an example implementation (or aspect) combinable with any example implementation (or aspect), the Fischer-Tropsch reactor comprises a wax encapsulating the preloaded catalyst.

In an example implementation (or aspect) combinable with any other example implementation (or aspect), the method comprises, after placing the portable GTL plant at the operational site, melting the wax to free the catalyst within the Fischer-Tropsch reactor.

In an example implementation (or aspect) combinable with any other example implementation (or aspect), the portable GTL plant comprises a vortex-assisted autothermal reforming reactor.

In an example implementation (or aspect) combinable with any other example implementation (or aspect), operating the portable GTL plant comprises forming, by the vortex-assisted autothermal reforming reactor, a syngas from an oxidizer stream and at least a portion of the light hydrocarbon feed.

In an example implementation (or aspect) combinable with any other example implementation (or aspect), operating the portable GTL plant comprises forming the liquid hydrocarbons from at least a portion of the syngas.

In an example implementation (or aspect) combinable with any other example implementation (or aspect), the liquid hydrocarbons comprise carbon compounds of about eight to about 20 carbons.

In an example implementation (or aspect) combinable with any other example implementation (or aspect), the method comprises placing the portable GTL plant at a second operational site different from the operational site and operating the portable GTL plant at the second operational site.

In an example implementation (or aspect), a reforming reactor comprises: a partial oxidation burner comprising; a mixing chamber having a first end and a second end, wherein the mixing chamber comprises a wall extending from the first end to the second end, wherein the mixing chamber comprises a first inlet configured to direct a light hydrocarbon feed in a vortex around an inner surface of the wall toward the first end, wherein the mixing chamber has a second inlet for an oxidizer stream at the first end, in fluid communication with the light hydrocarbon feed directed in the vortex within the mixing chamber; and an ignitor configured to initiate combustion of the light hydrocarbon feed in the presence of the oxidizer stream and produce a combustion product stream; and a reforming chamber configured to receive the combustion product stream, wherein the reforming chamber is configured to convert the combustion product stream into syngas.

In an example implementation (or aspect), a method for producing liquid hydrocarbons comprises: flowing a light hydrocarbon stream into an autothermal reformer; flowing an oxidizer stream into the autothermal reformer; mixing the light hydrocarbon stream and the oxidizer stream in a reverse vortex within the autothermal reformer; partially oxidizing the light hydrocarbon stream with the oxidizer stream within the autothermal reformer to form a syngas stream; and flowing the syngas stream from the autothermal reformer to a Fischer-Tropsch reactor comprising a catalyst to convert at least a portion of the syngas to a product stream comprising liquid hydrocarbons.

In an example implementation (or aspect) combinable with any other example implementation (or aspect), the method comprises separating oxygen from air to form the oxidizer stream.

In an example implementation (or aspect) combinable with any other example implementation (or aspect), the method comprises pressurizing the oxidizer stream with a centrifugal gas compressor.

In an example implementation (or aspect) combinable with any other example implementation (or aspect), the light hydrocarbon stream comprises methane, ethane, butane, propane, pentane, hexane, septane, octane, nonane, decane, or any combinations thereof.

In an example implementation (or aspect) combinable with any other example implementation (or aspect), the method comprises flowing steam into the autothermal reformer for mixing with the light hydrocarbon stream and the oxidizer stream within the autothermal reformer.

In an example implementation (or aspect) combinable with any other example implementation (or aspect), the method comprises recycling at least a portion of the product stream to the Fischer-Tropsch reactor.

In an example implementation (or aspect) combinable with any other example implementation (or aspect), recycling at least the portion of the product stream to the Fischer-Tropsch reactor comprises mixing the portion of the product stream with the syngas upstream of the Fischer-Tropsch reactor.

In an example implementation (or aspect) combinable with any other example implementation (or aspect), the method comprises recycling at least a portion of the product stream to the autothermal reformer.

In an example implementation (or aspect) combinable with any other example implementation (or aspect), recycling at least a portion of the product stream to the autothermal reformer comprises mixing the portion of the product stream with the light hydrocarbon stream upstream of the autothermal reformer.

In an example implementations (or aspect), a method for partially oxidizing light hydrocarbons comprising: flowing a light hydrocarbon stream into a first chamber of an autothermal reformer, wherein the first chamber comprises a first end, a second end, and a wall extending from the first end to the second end; flowing an oxidizer stream comprising oxygen into the first chamber, wherein the oxidizer stream is flowed to the first end of the first chamber; flowing the light hydrocarbon stream in a spiral pattern to form a reverse vortex within the autothermal reformer from the first end to the second end; mixing the light hydrocarbon stream and the oxidizer stream within the autothermal reformer; flowing the mixture within the first chamber to the second end; flowing the mixture from the second end to a second chamber comprising a catalyst; reacting the mixture in the presence of the catalyst within the second chamber to produce a syngas stream comprising carbon monoxide and hydrogen; and discharging the syngas stream from the second chamber.

In an example implementation (or aspect) combinable with any other example implementation (or aspect), the method comprises adjusting a ratio of a flow rate of the oxidizer stream to a flow rate of the light hydrocarbon stream, such that an extent of partial oxidation of the light hydrocarbon stream is increased.

In an example implementation (or aspect) combinable with any other example implementation (or aspect), the reverse vortex of the mixture flowing within the first chamber is concentrated along a central longitudinal axis of the first chamber.

In an example implementation (or aspect), a method for operating a portable GTL plant, the method comprising: transporting the portable GTL plant to an operational site, wherein the portable GTL plant has a longitudinal axis and a transverse axis, wherein the portable GTL plant comprises a reaction chamber pivotably having a second longitudinal axis and a second transverse axis, wherein the second longitudinal axis of the reaction chamber is aligned with the longitudinal axis of the portable GTL plant during transport; after transporting the portable GTL plant to the operational site, rotating the reaction chamber, such that the second longitudinal axis of the reaction chamber is perpendicular to the longitudinal axis of the portable GTL plant; and operating the portable GTL plant.

In an example implementation (or aspect), a method for producing hydrocarbon liquids from light hydrocarbons, the method comprising: placing a portable GTL plant at an operational site; coupling the portable GTL plant to a light hydrocarbon feedstock; converting, by the portable GTL plant, the light hydrocarbon feedstock to syngas; flowing the syngas over a catalyst to produce the hydrocarbon liquids; collecting the hydrocarbon liquids; transporting the portable GTL plant to a service center; performing service or maintenance on the portable GTL plant at the service center; transporting the portable GTL plant to a second operational site; and operating the portable GTL plant at the second operational site.

In an example implementation (or aspect), a method for producing liquid hydrocarbons in a range of C6 to C30 at a production location having a source of light hydrocarbon feedstock, the method comprising: placing a first portable GTL plant at a first operational site having a source of a first light hydrocarbon feedstock; coupling the first portable GTL plant to the first source; operating the first portable GTL plant to convert at least a portion of the first light hydrocarbon feedstock to a first liquid hydrocarbon product comprising hydrocarbons in a range of C6 to C30; placing a second portable GTL plant at a second operational site having a second source of a second light hydrocarbon feedstock; coupling the second portable GTL plant to the second source; operating the second portable GTL plant to convert at least a portion of the second light hydrocarbon feedstock to a second liquid hydrocarbon product comprising hydrocarbons in a range of C6 to C30; transporting the first portable GTL plant to a service center; performing service or maintenance on the first portable GTL plant at the service center; transporting the first portable GTL plant from the service center to a third operational site having a third source of a third light hydrocarbon feedstock; coupling the first portable GTL plant to the third source; and operating the first portable GTL plant to convert at least a portion of the third light hydrocarbon feedstock to a third liquid hydrocarbon product comprising hydrocarbons in a range of C6 to C30.

In an example implementation (or aspect) combinable with any other example implementation (or aspect), the first portable GTL plant is operated remotely free of local human assistance at the first operational site.

In an example implementation (or aspect) combinable with any other example implementation (or aspect), the second portable GTL plant is operated remotely free of local human assistance at the second operational site.

In an example implementation (or aspect) combinable with any other example implementation (or aspect), the first portable GTL plant is operated remotely free of local human assistance at the third operational site.

In an example implementation (or aspect) combinable with any other example implementation (or aspect), remotely operating the first portable GTL plant and the second portable GTL plant comprises transmitting operating data from the respective portable GTL plant to a remote location.

In an example implementation (or aspect) combinable with any other example implementation (or aspect), remotely operating the first portable GTL plant and the second portable GTL plant comprises receiving the transmitted operating data at the remote location.

In an example implementation (or aspect) combinable with any other example implementation (or aspect), remotely operating the first portable GTL plant and the second portable GTL plant comprises processing the received operating data at the remote location.

In an example implementation (or aspect) combinable with any other example implementation (or aspect), remotely operating the first portable GTL plant and the second portable GTL plant comprises transmitting control data from the remote location to at least one of the first portable GTL plant or the second portable GTL plant to control operation of the at least one of the first portable GTL plant or the second portable GTL plant.

In an example implementation (or aspect) combinable with any other example implementation (or aspect), the first light hydrocarbon feedstock comprises natural gas.

In an example implementation (or aspect) combinable with any other example implementation (or aspect), the second light hydrocarbon feedstock comprises natural gas.

In an example implementation (or aspect) combinable with any other example implementation (or aspect), the third light hydrocarbon feedstock comprises natural gas.

In an example implementation (or aspect), a system comprising: a plurality of portable GTL plants, wherein each portable GTL plant is configured to convert light hydrocarbons to hydrocarbon liquids comprising hydrocarbons in a range of C6 to C30, wherein each portable GTL plant comprises a reactor and a catalyst disposed within the reactor, wherein each catalyst is disposed within the respective reactor during transport of the respective portable GTL plant.

In an example implementation (or aspect) combinable with any other example implementation (or aspect), the system comprises a remote data network in communication with each portable GTL plant of the plurality of portable GTL plants.

In an example implementation (or aspect) combinable with any other example implementation (or aspect), each portable GTL plant of the plurality of portable GTL plants are located at different operational sites.

In an example implementation (or aspect), a method for producing hydrocarbon liquids from a source of light hydrocarbons, the method comprising: generating a plurality of portable GTL plants, wherein each portable GTL plant is configured to convert light hydrocarbons to hydrocarbon liquids comprising hydrocarbons in a range of C6 to C30; transporting each portable GTL plant to a different operational site, wherein each operational site comprises a respective source of light hydrocarbons; for each portable GTL plant located at the respective operational site: coupling the source of light hydrocarbons to the respective portable GTL plant; and operating the portable GTL plant to convert at least a portion of the respective light hydrocarbons to hydrocarbon liquids.

In an example implementation (or aspect) combinable with any other example implementation (or aspect), each portable GTL plant is remotely operated from a remote location different from the operational sites, independent of human assistance.

In an example implementation (or aspect) combinable with any other example implementation (or aspect), each portable GTL plant is operated at the respective operational site until servicing is required.

In an example implementation (or aspect) combinable with any other example implementation (or aspect), each portable GTL plant is retrieved from the respective operational site when servicing is required and transported to a service center different from the respective operational site.

In an example implementation (or aspect) combinable with any other example implementation (or aspect), each portable GTL plant is serviced at the service center.

In an example implementation (or aspect) combinable with any other example implementation (or aspect), each portable GTL plant is returned to the respective operational site after servicing at the service center.

In an example implementation (or aspect) combinable with any other example implementation (or aspect), the method comprises producing water.

In an example implementation (or aspect) combinable with any other example implementation (or aspect), the method comprises capturing waste heat from cooling.

In an example implementation (or aspect) combinable with any other example implementation (or aspect), the method comprises using the captured waste heat to generate steam.

In an example implementation (or aspect) combinable with any other example implementation (or aspect), generating the steam comprises using the captured waste heat to vaporize at least a portion of the water produced.

In an example implementation (or aspect) combinable with any other example implementation (or aspect), flowing the generated steam through a steam turbine to expand the steam and generate electrical power.

In an example implementation (or aspect) combinable with any other example implementation (or aspect), the method comprises venting at least a portion of the generated steam to atmosphere.

In an example implementation (or aspect) combinable with any other example implementation (or aspect), an amount of generated steam vented to atmosphere is substantially equal to an amount of water produced.

In an example implementation (or aspect) combinable with any other example implementation (or aspect), an amount of generated steam is vented to a burner to combust contaminants in the generated steam.

In an example implementation (or aspect) combinable with any other example implementation (or aspect), generated steam comprises contaminants such as for example, alcohols, aldehydes, ketones, carboxylic acids, carbon dioxide, ammonia, hydrogen sulfide, inorganic compounds and potentially BTEX and alkanes.

In an example implementation (or aspect) combinable with any other example implementation (or aspect), an amount of generated steam is heated to a temperature to cause at least some of the contaminants to thermally degrade before the steam is vented or condensed and disposed of.

In an example implementation (or aspect) combinable with any other example implementation (or aspect), generating the electrical power from flowing the generated steam through the steam turbine reduces a cooling requirement of the overall system.

In an example implementation (or aspect) combinable with any other example implementation (or aspect), at least a portion of the generated electrical power is used for heating.

What is claimed is:

1. A portable gas-to-liquids (GTL) plant for producing a liquid hydrocarbon from a gaseous hydrocarbon feed, comprising:
a reforming reactor to form a syngas from an oxidizer stream and the gaseous hydrocarbon feed; and
a Fischer-Tropsch reactor to form a hydrocarbon outlet stream from the syngas, wherein the hydrocarbon outlet stream comprises carbon compounds of about eight to about 20 carbons, wherein the Fischer-Tropsch reactor comprises a rotatable tower comprising a preloaded catalyst disposed within the Fischer-Tropsch reactor, and wherein the rotatable tower comprising the catalyst is in a horizontal position during shipping and the rotatable tower comprising the catalyst is in a vertical position during operation.

2. The portable GTL plant of claim 1, comprising a skid mount base configured to be placed on a tractor trailer.

3. The portable GTL plant of claim 1, comprising a desulfurization unit comprising a desulfurization catalyst to form the gaseous hydrocarbon feed, wherein the gaseous hydrocarbon feed is substantially free of sulfur.

4. The portable GTL plant of claim 1, comprising an air separation unit configured to separate oxygen from air to form the oxidizer stream.

5. The portable GTL plant of claim 1, comprising a recycle line configured to recycle at least a portion of the hydrocarbon outlet stream to mix with the hydrogen depleted stream entering the Fischer-Tropsch reactor.

6. The portable GTL plant of claim 1, wherein the reforming reactor is a vortex-assisted autothermal reforming reactor comprising a partial oxidation burner and a reformer chamber, wherein the partial oxidation burner comprises:
an oxidizer inlet for the oxidizer stream;
an outer enclosure; and
an inner mixing chamber.

7. The portable GTL plant of claim 6, comprising a diffuser block disposed after the oxidizer inlet in the oxidizer stream, wherein the diffuser block prevents flashback from the partial oxidation burner into the oxidizer inlet.

8. The portable GTL plant of claim 6, wherein the vortex-assisted autothermal reforming reactor comprises:
a hollow annulus between the outer enclosure and the inner mixing chamber;
a feed inlet for the desulfurized hydrocarbon stream, wherein the feed inlet is disposed in an upper portion of the hollow annulus, wherein the desulfurized hydrocarbon stream is directed in a spiral around the inner mixing chamber, and wherein the desulfurized hydrocarbon stream is introduced into the mixing chamber through ports disposed in a lower portion of the hollow annulus; and
an igniter disposed in an upper portion of the mixing chamber, wherein the igniter initiates a partial oxidation reaction between the oxidizer stream and the desulfurized hydrocarbon stream.

9. The portable GTL plant of claim 6, wherein the oxidizer stream comprises oxygen and steam.

10. The portable GTL plant of claim 6, wherein an outlet of the mixing chamber is coupled to an inlet of the reformer chamber, and wherein combustion products from the mixing chamber are fed to the reformer chamber, and wherein the reformer chamber comprises a reforming catalyst.

11. The portable GTL plant of claim 10, wherein the reforming catalyst comprises nickel metal supported on alumina.

12. The portable GTL plant of claim 1, wherein the hydrogen separation membrane comprises platinum.

13. The portable GTL plant of claim 1, wherein the hydrogen separation membrane comprises a polymer.

14. The portable GTL plant of claim 1, comprising a heat recovery steam generator to generate a steam stream.

15. The portable GTL plant of claim 14, comprising a steam turbine generator.

16. A method for producing liquid hydrocarbons from a light hydrocarbon feed in a portable gas-to-liquids (GTL) plant, comprising:
placing the portable GTL plant at an operational site, wherein the portable GTL plant comprises a Fischer-Tropsch reactor comprising a preloaded catalyst for forming a hydrocarbon outlet stream from a light hydrocarbon feed stream, wherein the preloaded catalyst is disposed within the Fischer-Tropsch reactor while the portable GTL plant is placed at the operational site;
coupling the portable GTL plant to the light hydrocarbon feed;
placing the portable GTL plant in operation to produce hydrocarbon liquids comprising about 3 to about 20 carbon atoms;
operating the portable GTL plant until servicing is needed, wherein operating the portable GTL plant comprises forming a hydrocarbon outlet stream, in the Fischer-Tropsch reactor, from a light hydrocarbon feed stream;
shutting the portable GTL plant down;
disconnecting the light hydrocarbon feed; and
removing the portable GTL plant from the operational site.

17. The method of claim 16, wherein the Fischer-Tropsch reactor comprises a wax encapsulating the preloaded catalyst, and the method comprises, after placing the portable GTL plant at the operational site, melting the wax to free the catalyst within the Fischer-Tropsch reactor.

18. The method of claim 16, wherein the portable GTL plant comprises a vortex-assisted autothermal reforming reactor, wherein operating the portable GTL plant comprises:
forming, by the vortex-assisted autothermal reforming reactor, a syngas from an oxidizer stream and at least a portion of the light hydrocarbon feed;
forming the liquid hydrocarbons from at least a portion of the syngas, wherein the liquid hydrocarbons comprise carbon compounds of about eight to about 20 carbons; and
recovering waste heat and generating power from the recovered waste heat for facilitating operation of the portable GTL plant.

19. The method of claim 16, comprising placing the portable GTL plant at a second operational site different from the operational site and operating the portable GTL plant at the second operational site.

20. A reforming reactor comprising:
a partial oxidation burner, comprising:
a mixing chamber having a first end and a second end, wherein the mixing chamber comprises a wall extending from the first end to the second end, wherein the mixing chamber comprises a first inlet configured to direct a light hydrocarbon feed in a vortex around an inner surface of the wall toward the first end, wherein the mixing chamber has a second inlet for an oxidizer stream at the first end, in fluid communication with the light hydrocarbon feed directed in the vortex within the mixing chamber; and
an ignitor configured to initiate combustion of the light hydrocarbon feed in the presence of the oxidizer stream and produce a combustion product stream; and
a reforming chamber configured to receive the combustion product stream, wherein the reforming chamber is configured to convert the combustion product stream into syngas.
